(19) United States
(12) Patent Application Publication
(10) Pub. No.: US 2026/0200244 A1
(43) Pub. Date: Jul. 16, 2026

(54) PRINTING APPARATUS

(71) Applicant: CANON KABUSHIKI KAISHA, Tokyo (JP)

(72) Inventors: MOTOYUKI TAGUCHI, Tokyo (JP); TAKESHI SEKINO, Kanagawa (JP); NORIKO SATO, Kanagawa (JP); MASASHI ITO, Tokyo (JP); TOSHIAKI TOKISAWA, Tokyo (JP); KENTO TAMARI, Saitama (JP); HIROSHI NAKAI, Kanagawa (JP); YUSUKE NISHIYA, Kanagawa (JP)

(21) Appl. No.: 19/561,247

(22) Filed: Mar. 9, 2026

Related U.S. Application Data
(63) Continuation of application No. PCT/JP2024/032764, filed on Sep. 12, 2024.

(30) Foreign Application Priority Data
Sep. 14, 2023 (JP) 2023-149554
Sep. 11, 2024 (JP) 2024-157731

(51) Int. Cl. B41J 11/00; B41J 3/60; B41J 11/02; B41J 13/08; B41J 13/10; B41J 25/00; B41J 29/13

(52) U.S. Cl. CPC B41J 11/006; B41J 3/60; B41J 11/02; B41J 13/08; B41J 13/103; B41J 25/001; B41J 29/13

(57) ABSTRACT

A printing apparatus includes a storage cassette on which a print medium is stacked, a conveying unit configured to convey the print medium to a printhead, a carriage on which the printhead is mounted, and a driving unit configured to move the carriage. The storage cassette is configured to be attached/detached from a front surface of a main body of the printing apparatus in a front/rear direction of the printing apparatus with respect to the main body. The conveying unit conveys the print medium from a front side to a rear side in the front/rear direction. The driving unit moves the carriage in a direction crossing the front/rear direction and is arranged on the rear side with respect to the printhead in the front/rear direction.

### CROSS-REFERENCE TO RELATED APPLICATIONS

This application is a Continuation of International Patent Application No. PCT/JP2024/032764, filed September 12, 2024, which claims the benefit of Japanese Patent Applications No. 2023-149554, filed September 14, 2023 and No. 2024-157731, filed September 11, 2024, which are hereby incorporated by reference herein in their entirety.

### BACKGROUND

### Field of the Technology

The present disclosure relates to a printing apparatus.

### DESCRIPTION OF THE RELATED ART

There is known a printing apparatus that includes a printhead mounted on a carriage and performs printing while moving the printhead. Japanese Patent No. 7089667 discloses an apparatus that has a path for determining the obverse and reverse surfaces of a print medium and returning it to a printhead and can perform double-sided printing of the print medium.

A print medium conveyed to the printhead sometimes causes jam on the periphery of the printhead. To eliminate such jam, an operator needs to access the upstream side of the printhead in the conveyance direction of the print medium. However, accessibility depends on the existence of an internal structure in the printing apparatus.

### SUMMARY

The present disclosure provides a printing apparatus that improves accessibility to the upstream side of a printhead.

According to an aspect of the present disclosure, there is provided a printing apparatus comprising: a storage cassette on which a print medium is stacked; a conveying unit configured to convey the print medium to a printhead; a carriage on which the printhead is mounted; and a driving unit configured to move the carriage, wherein the storage cassette is configured to be attached/detached from a front surface of a main body of the printing apparatus in a front/rear direction of the printing apparatus with respect to the main body, the conveying unit is configured to convey the print medium from a front side to a rear side in the front/rear direction, and the driving unit is configured to move the carriage in a direction crossing the front/rear direction and is arranged on the rear side with respect to the printhead in the front/rear direction.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing the outer appearance of a printing apparatus according to an embodiment;

FIG. 2 is a schematic view of the internal structure of the printing apparatus shown in FIG. 1;

FIG. 3 is a perspective view of a printing unit;

FIG. 4 is a sectional view taken along a line B - B in FIG. 3;

FIG. 5 is a schematic view of the internal structure of the printing apparatus shown in FIG. 1 in which an opening/closing member is in an open state;

FIG. 6 is a plan view of the printing apparatus shown in FIG. 1 in which the opening/closing member is in an open state;

FIG. 7 is a schematic view of the internal structure of the printing apparatus shown in FIG. 1 in which a storage cassette is detached;

FIG. 8 is a perspective view of the printing apparatus shown in FIG. 1 in which a storage cassette is detached;

FIG. 9 is a perspective view of the storage cassette;

FIG. 10 is a schematic view of the internal structure of the printing apparatus shown in FIG. 1 in which an attaching/detaching unit is detached;

FIG. 11 is a perspective view of the attaching/detaching unit;

FIG. 12 is a sectional view taken along a line C - C in FIG. 11;

FIG. 13 is a view showing another example of the configuration of an opening portion;

FIG. 14 is a view showing still another example of the configuration of the opening portion;

FIG. 15 is a view showing another example of the configuration of a sub conveyance path;

FIG. 16 is a view showing an example of the configuration of the printing apparatus to which a feeding tray is added;

FIG. 17 is a view showing an example of the configuration of the printing apparatus to which a feeding tray is added;

FIG. 18 is a view showing the outer appearance of a printing apparatus according to another embodiment;

FIG. 19 is a view of the outer appearance of the printing apparatus shown in FIG. 18 to which a plurality of optional devices are attached;

FIG. 20 is a view showing a mode in which a storage cassette is detached in the printing apparatus shown in FIG. 18;

FIG. 21 is a view showing a mode in which an attaching/detaching unit is detached in the printing apparatus shown in FIG. 18;

FIG. 22 is a view showing a mode in which an opening/closing member is in an open state in the printing apparatus shown in FIG. 18;

FIG. 23 is a view showing a mode in which an opening/closing member is in an open state in the printing apparatus shown in FIG. 18;

FIG. 24 is a schematic view of the internal structures of the printing apparatus and the optional devices shown in FIG. 19;

FIG. 25 is a perspective view of a printing unit;

FIG. 26 is a sectional view taken along a line D - D in FIG. 25;

FIG. 27 is a view showing a state in which a cover and a feeding tray are extracted in the printing apparatus shown in FIG. 19;

FIG. 28 is a schematic view of the internal structure of the printing apparatus shown in FIG. 27;

FIG. 29 is a view of the outer appearance of a printing apparatus 1A shown in FIG. 19 in which the opening/closing member is in an open state;

FIG. 30 is a plan view of the printing apparatus 1A shown in FIG. 19 in which the opening/closing member is in an open state;

FIG. 31 is a schematic view of the internal structure of the printing apparatus shown in FIG. 18 in which an attaching/detaching unit is detached;

FIG. 32 is a perspective view of the attaching/detaching unit;

FIG. 33 is a plan view showing the internal structure of the attaching/detaching unit;

FIG. 34 is a sectional view taken along a line E - E in FIG. 32;

FIG. 35 is a sectional view taken along a line E - E in FIG. 32;

FIG. 36 is an explanatory view of a sensor;

FIG. 37 is an explanatory view of a sensor; and

FIG. 38 is an explanatory view of a sensor.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Outline of Printing Apparatus

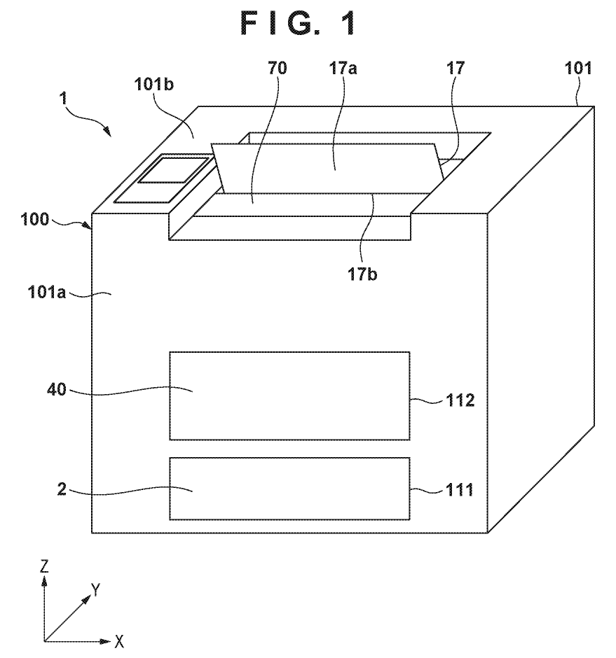

FIG. 1 is a view showing the outer appearance of a printing apparatus 1 according to an embodiment. In this embodiment, a case where the present disclosure is applied to a serial-type inkjet printing apparatus will be described. However, the present disclosure can also be applied to a printing apparatus of another type.

Note that "print" includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a "print medium", cloth, a plastic film, and the like may also be used.

In the drawings, arrows X, Y, and Z indicate directions crossing each other. The arrows X and Y indicate horizontal directions that are orthogonal to each other, and the arrow Z indicates the up/down direction. The X direction corresponds to the left/right direction (the widthwise direction) of the printing apparatus 1, and the Y direction corresponds to the front/rear direction (the depth direction) of the printing apparatus 1. The Z direction corresponds to the height direction of the printing apparatus 1. Also, the downstream side and the upstream side are defined based on the conveyance direction of a print medium as a reference.

The printing apparatus 1 includes a main body 100, a storage cassette 2 that can be attached/detached to/from the main body 100, and an attaching/detaching unit 40. The main body 100 includes a housing 101 having a substantially rectangular parallelepiped shape, and the housing 101 forms the outer wall of the printing apparatus 1. On a front surface 101a of the housing 101 forming the front portion of the printing apparatus 1, slots 111 and 112 that enable attachment/detachment of the storage cassette 2 storing a print medium and the attaching/detaching unit 40 for maintenance to/from the main body 100 are formed. The slot 111 opens to the front surface 101a and extends in the Y direction, and the storage cassette 2 is inserted/removed in/from the slot 111 in the Y direction. The slot 112 also opens to the front surface 101a and extends in the Y direction, and the attaching/detaching unit 40 is inserted/removed in/from the slot 112 in the Y direction. The storage cassette 2 is located on the lower side of the attaching/detaching unit 40, thereby facilitating ensuring the storage amount of the print medium and ensuring a feeding path.

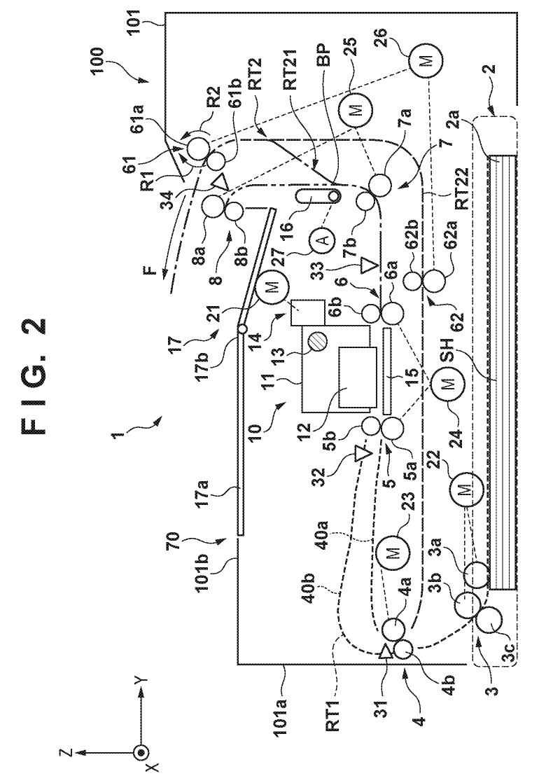

An opening portion 70 that exposes the interior of the printing apparatus 1 is formed in the upper surface of the housing 101 that forms the upper portion of the main body 100. The opening portion 70 is opened/closed by an opening/closing member 17a. In this embodiment, the opening/closing member 17a is a plate-shaped tray member forming a part of a discharge tray 17, and is a rotation member provided to be rotatable about a rotation center axis 17b in the X direction. FIG. 1 shows a state in which the opening/closing member 17a is in an open state, and the opening portion 70 is open. When the opening/closing member 17a is set in a closed state as shown in FIG. 2, the opening portion 70 is closed.

FIG. 2 is a schematic view of the internal structure of the printing apparatus 1. The printing apparatus 1 performs printing on a sheet SH that is a print medium before printing and is stacked on a feeding tray 2a in the storage cassette 2. In addition, the printing apparatus 1 discharges the printed sheet SH to a discharge tray 17. It is possible to detach the storage cassette 2 from the main body 100 of the printing apparatus 1 and set the sheet S on the feeding tray 2a of the detached storage cassette 2.

A main conveyance path RT1 that guides conveyance of the sheet SH is formed from the feeding tray 2a to the discharge tray 17. Also, the printing apparatus 1 includes a sub conveyance path RT2 branched from the main conveyance path RT1 at a branch point BP. The sub conveyance path RT2 is an inverting path configured to invert the sheet SH and return it to the main conveyance path RT1 and is used to perform double-sided printing for the sheet SH. Note that the printing apparatus 1 may not have the double-sided printing function for the sheet SH, and in this case, the sub conveyance path RT2 and associated components are unnecessary.

Note that the main conveyance path RT1 or the sub conveyance path RT2 is formed by path forming members. As an example of the path forming member, FIG. 2 schematically shows a path forming member 40b on the upper side and a path forming member 40a on the lower side in the section between a feeding unit 4 and a conveying unit 5. A conveyance path is defined by such path forming members.

The sheets SH on the feeding tray 2a are introduced to the main conveyance path RT1 one by one by a feeding unit 3. The feeding unit 3 is a pickup mechanism that picks up the sheet SH from the feeding tray 2a using a feeding motor 22 as a driving source. The feeding unit 3 includes a feeding roller (pickup roller) 3a, a feeding roller 3b, and a separation roller 3c.

The feeding roller 3a contacts the uppermost surface of the sheet SH stacked on the feeding tray 2a and is rotated by driving from the feeding motor 22, thereby starting feeding the sheet SH. The feeding roller 3b that is rotated by driving from the feeding motor 22 and the separation roller 3c that forms a nip portion with the feeding roller 3b are arranged on the downstream side of the feeding roller 3a. The separation roller 3c is a roller that includes a torque limiter and has a rotational resistance. If two or more sheets SH enter the nip portion between the feeding roller 3b and the separation roller 3c, the sheet SH is separated one by one by the rotational resistance of the separation roller 3c.

The printing apparatus 1 includes the feeding unit 4 and a plurality of conveying units 5 to 8. The feeding unit 4, the conveying unit 5, the conveying unit 6, the conveying unit 7, and the conveying unit 8 are arranged in this order from the upstream side to the downstream side in the conveyance direction of the sheet SH in the main conveyance path RT1. Conveying units 61 and 62 are arranged along the sub conveyance path RT2, and the conveying unit 61 and the conveying unit 62 are arranged in this order from the upstream side to the downstream side in the conveyance direction of the sheet SH in the sub conveyance path RT2. Note that in the following explanation, the leading edge and the trailing edge of the sheet SH mean the downstream end and the upstream end of the sheet SH, unless specified otherwise.

The feeding unit 4 conveys the sheet SH introduced to the main conveyance path RT1 by the feeding unit 3, or the sheet SH returned from the sub conveyance path RT2 to the main conveyance path RT1, to the conveying unit 5. The feeding unit 4 includes a feeding roller 4a, and a driven roller 4b that is pressed against the feeding roller 4a by a spring or the like (not shown). The feeding roller 4a is a rotating body that is rotated by the driving force of a feeding motor 23, and the driven roller 4b is a rotating body that rotates following the rotation of the feeding roller 4a.

The sheet SH is clamped in the nip portion between the feeding roller 4a and the driven roller 4b and conveyed by the rotation of the feeding roller 4a and the driven roller 4b. Note that the feeding rollers 3a and 3b are one-way rollers. Hence, after the sheet SH is conveyed to a position exceeding the nip portion of the feeding unit 4, conveyance by the feeding unit 4 can be continued even if driving of the feeding unit 3 is stopped.

Note that this embodiment includes the feeding unit 3 and the feeding unit 4, but only the feeding unit 3 that feeds the sheet SH stacked on the feeding tray 2a may be provided.

A sensor 31 is a sensor that detects passage of the leading edge and trailing edge of the sheet SH and is, for example, an optical sensor. The detection position of the sensor 31 is set to a position on the downstream side of the nip portion of the feeding unit 4. After passage of the leading edge of the sheet SH is detected, the detection result of the sensor 31 can be used as a trigger for control to, for example, stop driving of the feeding unit 3 or increase the conveyance speed of the feeding unit 4.

The conveying unit 5 is arranged on the upstream side of a printhead 12, and the sheet is conveyed by the conveying unit 5 to the downstream side between the printhead 12 and a platen 15 facing the printhead 12. The conveying unit 5 includes a conveyance roller 5a, and a driven roller (pinch roller) 5b that is pressed against the conveyance roller 5a by a spring or the like (not shown). The conveyance roller 5a is a rotating body that is rotated by the driving force of a conveyance motor 24, and the driven roller 5b is a rotating body that rotates following the rotation of the conveyance roller 5a. The sheet SH is clamped in the nip portion between the conveyance roller 5a and the driven roller 5b and conveyed by the rotation of the conveyance roller 5a and the driven roller 5b.

Like the sensor 31, a sensor 32 is a sensor that detects passage of the leading edge and trailing edge of the sheet SH and is an optical sensor. Since the sensor 32 is arranged on the upstream side near the conveying unit 5, the detection result can be used to manage the loop amount of registration of the sheet SH or the position of the leading edge of the sheet SH.

The conveying unit 6 is arranged on the downstream side of the printhead 12, and conveys the sheet SH conveyed by the conveying unit 5 up to the conveying unit 8 on the downstream side. The conveying unit 6 includes a conveyance roller 6a, and a spur 6b that is pressed against the conveyance roller 6a by a spring or the like (not shown). The conveyance roller 6a is a rotating body that is rotated by the driving force of the conveyance motor 24, and the spur 6b is a rotating body that rotates following the rotation of the conveyance roller 6a. In this embodiment, the conveying unit 5 and the conveying unit 6 share the driving source (conveyance motor 24).

A sensor 33 is an optical sensor similar to the sensors 31 and 32 and is used to detect the leading edge and the trailing edge of the sheet SH.

The conveying unit 7 is arranged on the downstream side of the printhead 12 and the conveying unit 6, and conveys the sheet SH conveyed by the conveying unit 6 up to the downstream side. The conveying unit 7 includes a conveyance roller 7a, and a driven roller 7b that is pressed against the conveyance roller 7a by a spring or the like (not shown). The conveyance roller 7a is a rotating body that is rotated by the driving force of a conveyance motor 25, and the driven roller 7b is a rotating body that rotates following the rotation of the conveyance roller 7a. The sheet SH is clamped in the nip portion between the conveyance roller 7a and the driven roller 7b and conveyed by the rotation of the conveyance roller 7a and the driven roller 7b.

The conveying unit 8 is a discharge unit that is arranged on the downstream side of the printhead 12 and the conveying units 6 and 7, and discharges the sheet SH conveyed by the conveying unit 7 to the discharge tray 17. In single-sided printing, the sheet SH discharged to the discharge tray 17 is so-called "face-down discharge" in which an image printed surface faces down. In double-sided printing, the second printed surface faces down. In the main conveyance path RT1, the path from the conveying unit 6 to the conveying unit 8 is sometimes called a "discharge conveyance path".

The conveying unit 8 includes a conveyance roller 8a, and a driven roller 8b that is pressed against the conveyance roller 8a by a spring or the like (not shown). The conveyance roller 8a is a rotating body that is rotated by the driving force of the conveyance motor 25, and the driven roller 8b is a rotating body that rotates following the rotation of the conveyance roller 8a. The sheet SH is clamped in the nip portion between the conveyance roller 8a and the driven roller 8b and conveyed by the rotation of the conveyance roller 8a and the driven roller 8b.

In this embodiment, the conveying unit 7 and the conveying unit 8 share the driving source (conveyance motor 25). However, the conveyance motor 25 may be eliminated and the conveyance motor 24 that is the driving source of the conveying unit 5 and the conveying unit 6 may be shared by the conveying unit 7 and the conveying unit 8.

A sensor 34 is an optical sensor similar to the sensors 31 to 33 and is used to detect the leading edge and the trailing edge of the sheet SH. In this embodiment, discharge is completed after a predetermined conveyance amount from detection of the trailing edge of the sheet SH by the sensor 34, and the detection result of the sensor 34 can also be used to detect the discharge.

A flapper 16 is arranged at the branch point BP. The flapper 16 switches the path to the conveyance destination of the sheet SH between the main conveyance path RT1 and the sub conveyance path RT2. At the position shown in FIG. 2, the flapper 16 maintains the path to the conveyance destination of the sheet SH to the main conveyance path RT1, and the sheet SH is discharged to the discharge tray 17 via the conveying unit 8. The flapper 16 is rotatably provided and rotated by an actuator 27 such as an electromagnetic solenoid, thereby switching the path.

The conveying unit 61 is an inverting unit that conveys the sheet SH entering from the branch point BP to the sub conveyance path RT2. The sub conveyance path RT2 includes an inverting path RT21 extending upward from the branch point BP via a branch point BP', and a return path RT22 extending from the branch point BP' to the feeding unit 4, and forms a path that guides the sheet SH from the rear side of the printing apparatus 1 to the front side. The conveying unit 61 is arranged in the inverting path RT21. The conveying unit 61 includes a conveyance roller 61a, and a driven roller 61b that is pressed against the conveyance roller 61a by a spring or the like (not shown). The conveyance roller 61a is a rotating body that is rotated by the driving force of a conveyance motor 26, and the driven roller 61b is a rotating body that rotates following the rotation of the conveyance roller 61a.

The sheet SH entering the sub conveyance path RT2 from the branch point BP moves in the inverting path RT21. The conveyance roller 61a is rotated in two directions, that is, a direction R1 and an opposite direction R2. When the conveyance roller 61a rotates in the direction R1, the sheet SH is conveyed in the direction of an arrow F. When the trailing edge of the sheet SH passes the branch point BP', the rotation direction of the conveyance roller 61a is switched to the direction R2. The sheet SH is conveyed in the opposite direction. The sheet SH is inverted and introduced from the branch point BP' to the return path RT22.

The conveying unit 62 is an intermediate unit arranged in the return path RT22. The conveying unit 62 includes a conveyance roller 62a, and a driven roller 62b that is pressed against the conveyance roller 62a by a spring or the like (not shown). The conveyance roller 62a is a rotating body that is rotated by the driving force of the conveyance motor 26, and the driven roller 62b is a rotating body that rotates following the rotation of the conveyance roller 62a. The sheet SH is clamped in the nip portion between the conveyance roller 62a and the driven roller 62b and conveyed by the rotation of the conveyance roller 62a and the driven roller 62b. In this embodiment, the conveying unit 61 and the conveying unit 62 share the driving source (conveyance motor 26).

Note that the conveyance roller 62a is a one-way roller. Hence, after the sheet SH is conveyed to a position exceeding the nip portion of the feeding unit 4, conveyance by the feeding unit 4 can be continued even if driving of the conveyance roller 62a is stopped.

### Printing Unit

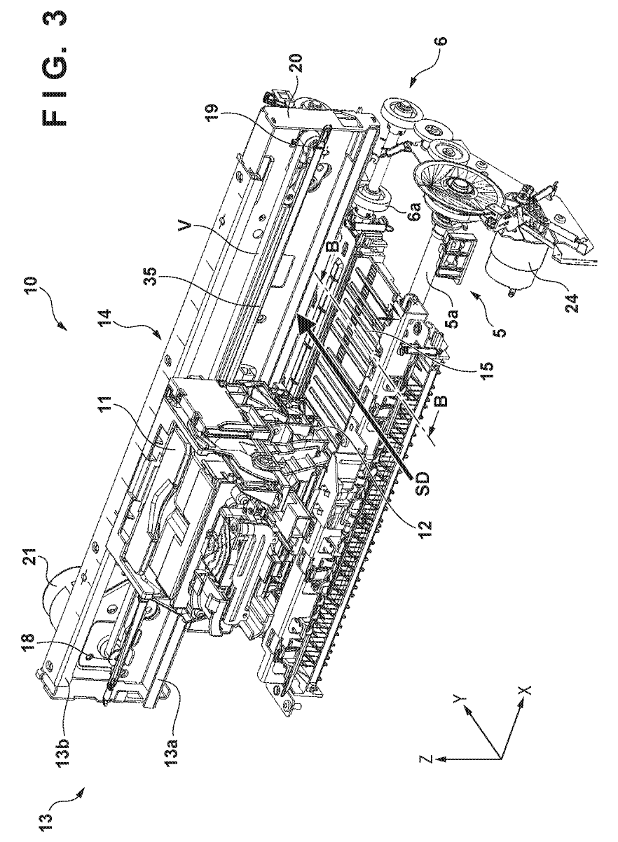

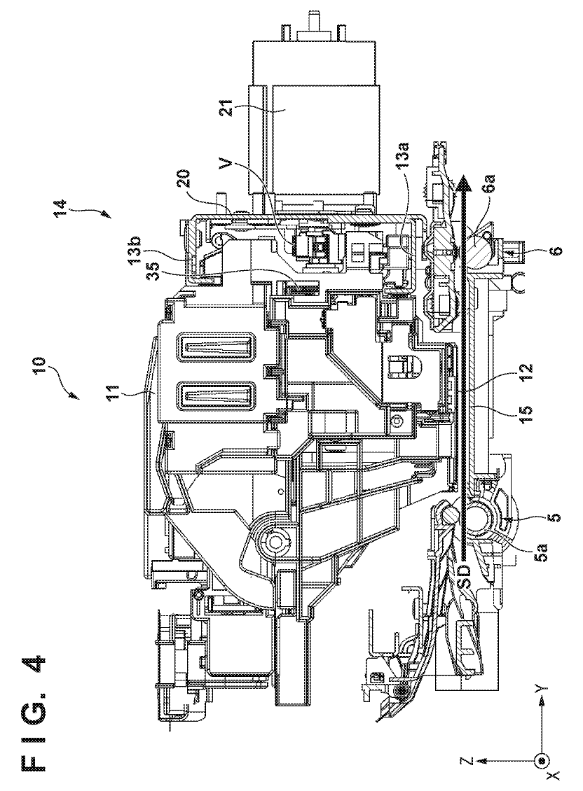

A printing unit 10 will be described with reference to FIGS. 3 and 4 in addition to FIG. 2. FIG. 3 is a perspective view of the printing unit 10, and FIG. 4 is a sectional view taken along a line B - B in FIG. 3. The printing unit 10 includes the printhead 12, a carriage 11, and a driving unit 14. The printhead 12 discharges liquid ink to the sheet SH, thereby printing an image on the sheet SH. The lower surface of the printhead 12 forms a discharge surface in which a plurality of nozzles for discharging ink are formed.

The method of supplying ink to the printhead 12 is, for example, a tube supply method that supplies ink, via a tube, from an ink tank arranged in a place separated from the carriage 11. However, there also exist an independent ink cartridge method in which the ink cartridge is mounted on the carriage 11 together with the printhead 12 and a head cartridge method in which the ink cartridge and the printhead 12 are integrated, and any method can be used.

The platen 15 is arranged to face the printhead 12 (particularly, the discharge surface) between the conveying unit 5 and the conveying unit 6. The sheet SH is conveyed in the direction of an arrow SD (Y direction) between the printhead 12 and the platen 15, and an image is printed by the printhead 12.

The printhead 12 is mounted on the carriage 11. The carriage 11 is reciprocally moved in a direction (in this embodiment, the X direction) crossing the direction SD by the driving unit 14.

The driving unit 14 includes a support member 20 extended in the X direction. The support member 20 is a base member that supports the components of the driving unit 14. The support member 20 is provided with a guide member 13 that engages with the carriage 11 and guides the movement of the carriage 11. In this embodiment, the guide member 13 includes a rail member 13a on the lower side and a rail member 13b on the upper side. The rail members 13a and 13b are apart in the Z direction and are extended in the X direction. The rail members 13a and 13b engage with the carriage 11 and guide the movement of the carriage 11. Note that the guide member 13 may be a member having a shaft form.

The rail member 13a supports the carriage 11 in the height (Z) direction and the front/rear (Y) direction. When the height (Z) of the rail member 13a is adjusted with respect to the support member 20, the height (Z position) of the printhead 12 with respect to the platen 15 can be adjusted. The rail member 13b is located above (+Z direction) the rail member 13a, and regulates the position of the carriage 11 about the X-axis. When the rail member 13b is adjusted with respect to the support member 20 in the front/rear (Y) direction, the tilt of the printhead 12 about the X-axis with respect to the platen 15 can be adjusted.

The driving unit 14 according to this embodiment is a belt transmission mechanism using a carriage motor 21 as a driving source. However, the driving unit 14 may be of a mechanism type other than the belt transmission mechanism. The carriage motor 21 is arranged on the opposite side of the carriage 11 in the Y direction across the support member 20. The driving unit 14 includes a driving pulley 18 and a driven pulley 19, which are apart in the X direction, and an endless belt V wound around these pulleys. These are arranged between the rail member 13a and the rail member 13b in the Z direction.

The carriage 11 is fixed to the endless belt V. When the carriage motor 21 rotates the driving pulley 18, the endless belt V travels, and the carriage 11 moves. A cord strip 35 is supported by the support member 20. A sensor (not shown) that detects the slit of the cord strip 35 is provided on the carriage 11, and it is therefore possible to specify the position of the carriage 11 in the X direction based on the detection result of the sensor.

An electrical contact between the printhead 12 and a board (not shown) is provided on the carriage 11. The board (not shown) may be arranged on the downstream side of the printhead 12 and between the carriage 11 and the support member 20.

An image printing operation will be described. In the process of movement of the carriage 11 in the X direction, ink is discharged from the printhead 12 to the sheet SH, thereby printing an image. This operation is called print scanning. The printing operation is performed by alternately repeating a conveyance operation of intermittently conveying the sheet SH in the direction SD by the conveying unit 5 and print scanning.

### Layout of Components around Printhead

FIGS. 2 to 4 will be referred to. The sheet SH may cause a jam around the printhead 12. The driving unit 14 is a structure having the support member 20 fixed like a wall member on the X-Z plane. The driving unit 14 of the carriage 11 readily becomes an obstacle when considering the accessibility of the operator to the point of jam.

In this embodiment, the driving unit 14 is arranged on the downstream side with respect to the printhead 12. The space on the upstream side of the printhead 12 is wide, and the accessibility of the operator to the upstream side of the printhead 12 is improved. As the form of a jam, the leading edge portion of the sheet SH is often jammed between the printhead 12 and the platen 15. Hence, since it is easy for the operator to work from the upstream side of the printhead 12, recovery work can be performed more smoothly.

When viewed in the front/rear direction (Y direction) of the printing apparatus 1, the conveying unit 5 is arranged on the front side with respect to the printhead 12, and the driving unit 14 is arranged on the rear side with respect to the printhead 12. As for the installation place of the printing apparatus 1, in many cases, the space on the front side of the printing apparatus 1 is wide, and the space on the rear side is narrow due to the presence of a wall or the like. In this embodiment, the space on the front side of the printhead 12 is wide. Hence, if a jam occurs, the operator can easily perform the recovery work from the front side of the printing apparatus 1.

Also, in this embodiment, the feeding unit 4 is arranged on the front side of the conveying unit 5. Even for a jam that occurs between the feeding unit 4 and the conveying unit 5, the operator can easily perform the recovery work from the front side of the printing apparatus 1.

### Structure Associated with Maintenance

### Maintenance around Printhead

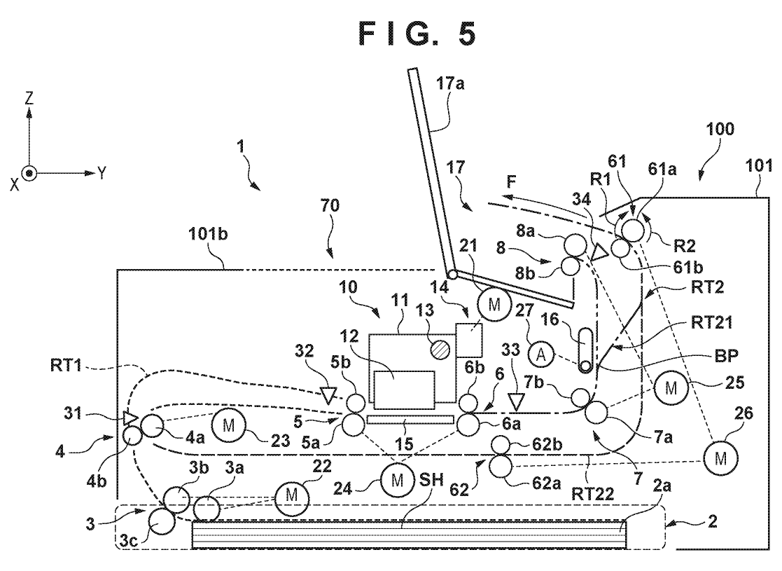

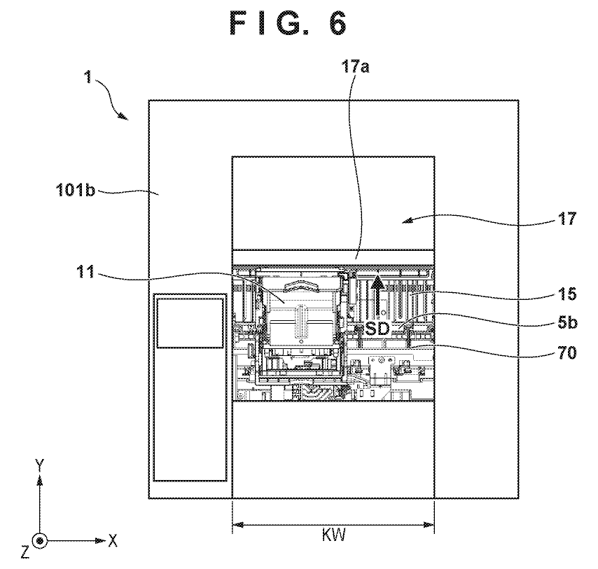

The printing apparatus 1 according to this embodiment has a structure that facilitates maintenance (access) to the printing unit 10. This will be described with reference to FIGS. 5 and 6. FIG. 5 is a schematic view of the internal structure of the printing apparatus 1 in which the opening/closing member 17a is in the open state, and FIG. 6 is a plan view of the printing apparatus 1 in which the opening/closing member 17a is in the open state.

Examples of maintenance to the printing unit 10 are the above-described recovery of jam and exchange of the printhead 12. In a form in which the ink tank is mounted on the carriage 11, a work of exchanging the ink tank is also included.

As for the opening portion 70, a portion of the opening portion 70 on the upstream side of the printhead 12 is formed to be exposed more than a portion on the downstream side. The opening/closing member 17a is arranged on the upper side (+Z direction) of the conveying unit 5. If the opening/closing member 17a is set in the open state, the conveying unit 5, the carriage 11, the printhead 12, the platen 15, and the like are exposed via the opening portion 70, and the operator can access these. In this embodiment, since the driving unit 14 is arranged on the downstream side of the printhead 12, the operator can easily access the conveying unit 5, the carriage 11, the printhead 12, the platen 15, and the like from the front side of the printing apparatus 1.

As shown in FIG. 6, defining the width of the opening portion 70 in the X direction as KW, the width KW is larger than the maximum width of the sheets SH supported by the printing apparatus 1. Hence, if the sheet SH causes a jam, the sheet SH can readily be removed from the opening portion 70.

Note that in this embodiment, the opening/closing member 17a rotates, but the opening portion 70 may be opened/closed by sliding the opening/closing member 17a.

### Maintenance around Storage Cassette

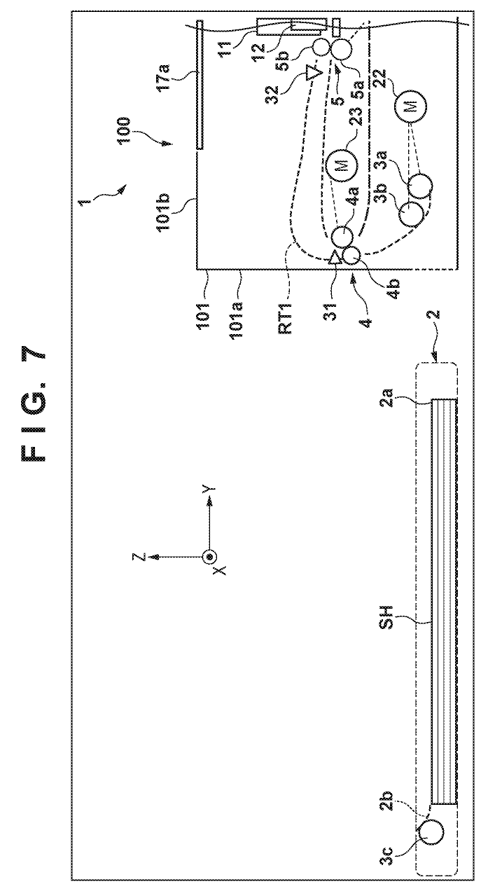

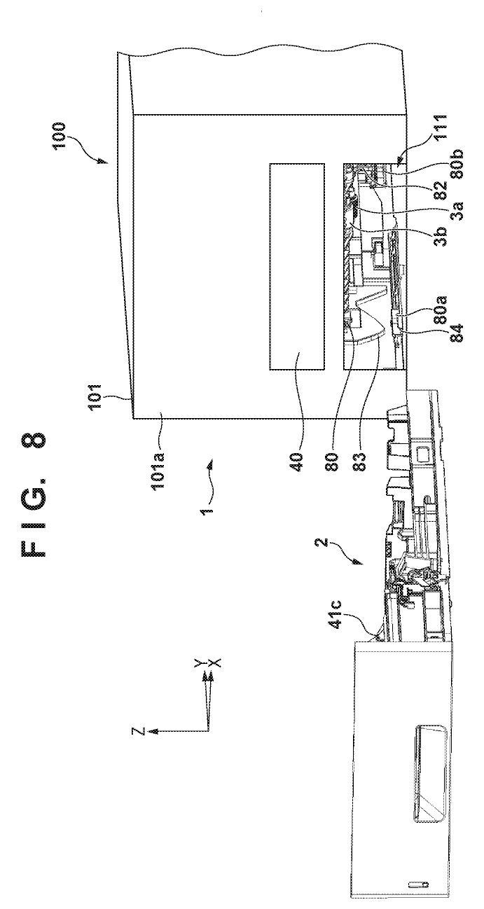

Maintenance that can be performed by attaching/detaching the storage cassette 2 will be described next with reference to FIGS. 7 to 9. FIG. 7 is a schematic view of the internal structure of the printing apparatus 1 in which the storage cassette 2 is detached, and FIG. 8 is a perspective view of the printing apparatus 1 in which the storage cassette 2 is detached. The separation roller 3c of the feeding unit 3 and a path forming member 2b forming a part of the main conveyance path RT1 are attached to the storage cassette 2. When the storage cassette 2 is detached from the main body 100 to the front side, these are also exposed. This facilitates recovery of jam of the sheet SH around the storage cassette 2.

In the slot 111, rails 80a and 80b that support the storage cassette 2 in the Z direction are installed to guide the movement of the storage cassette 2 when attaching/detaching the storage cassette 2 to/from the main body 100. Note that the rails 80a and 80b are provided on both sides of the slot 111 in the X direction.

On the upper side of the rail 80a, a pressing plate cam 83 that sets the position of a pressing plate 91 to be described later to a horizontal position when detaching the storage cassette 2 from the main body 100 is installed. Also, a pressing plate release cam 84 of the pressing plate 91 to be described later is provided at the distal end of the rail 80a, and this acts when attaching the storage cassette 2 to the main body 100. The pressing plate cam 83 and the pressing plate release cam 84 are provided on both sides of the slot 111 in the X direction, and the pressing plate 91 can be moved up/down by the cams (83 and 84) on the left and right sides.

When the storage cassette 2 is detached from the main body 100, the feeding rollers 3a and 3b remaining on the side of the main body 100 are exposed, and the operator can access these. The operator can perform, for example, a work of exchanging the feeding rollers 3a and 3b. The feeding rollers 3a and 3b are supported by one holder (not shown), and these can be exchanged simultaneously by detaching the holder. However, the feeding rollers 3a and 3b need not always be attached to one holder, and a configuration for detaching the feeding rollers 3a and 3b independently may be employed.

The storage cassette 2 will be described in more detail. The separation roller 3c is attached to a separation roller holder 95. The separation roller 3c can be exchanged by detaching the separation roller holder 95 from the storage cassette 2. In the storage cassette 2, the sheet SH can be stacked on the feeding tray 2a and the pressing plate 91 and stored.

It is possible to regulate the position of the sheet SH in the widthwise direction by side guides 85 and 86 and the position of the sheet SH in the longitudinal (conveyance) direction by an end guide 89 in accordance with the size of the stored sheet SH. An end lock portion 90 with a latch 90a is arranged at the center portion of the end guide 89 to prevent the end guide 89 from being shifted. For the side guide 85 as well, a side lock portion 87 is arranged to prevent the side guide 85 from being shifted.

The side guide 85 is connected to the side guide 86 by a rack & pinion (not shown) under the pressing plate 91. For this reason, when the side guide 85 is operated, the side guide 86 simultaneously operates, and the position of the sheet SH in the widthwise direction can be regulated. Also, the side guide 86 is provided with a side biasing plate 88 and biased in the X direction by a spring (not shown). Hence, the sheet SH stacked on the storage cassette 2 can be moved to one side in the X direction.

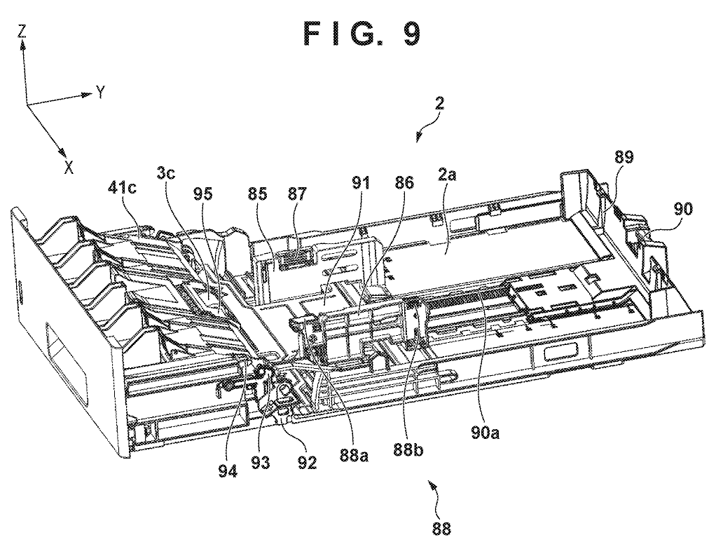

The pressing plate 91 is biased upward in the Z direction by a spring (not shown) installed under the pressing plate 91, and the stacked sheet SH can be pressed against the feeding roller 3a. The pressing plate 91 shown in FIG. 9 is at a position when the storage cassette 2 is detached from the main body 100, and the two end portions of the pressing plate 91 in the X direction are held by a pressing plate holding portion 92 in the Z direction. The pressing plate 91 is substantially parallel to the feeding tray 2a and substantially horizontal with respect to the XY plane. This is because when extracting the storage cassette 2 from the main body 100, the pressing plate cam 83 presses the end portion of the pressing plate 91 down and the pressing plate holding portion 92 can hold the pressing plate 91 in the Z direction. When attaching the storage cassette 2 to the main body 100, the pressing plate release cam 84 cancels holding of the pressing plate holding portion 92. The pressing plate 91 thus returns to the feeding position (a position where the sheet is pressed against the feeding roller 3a by spring biasing).

### Maintenance around Attaching/Detaching Unit

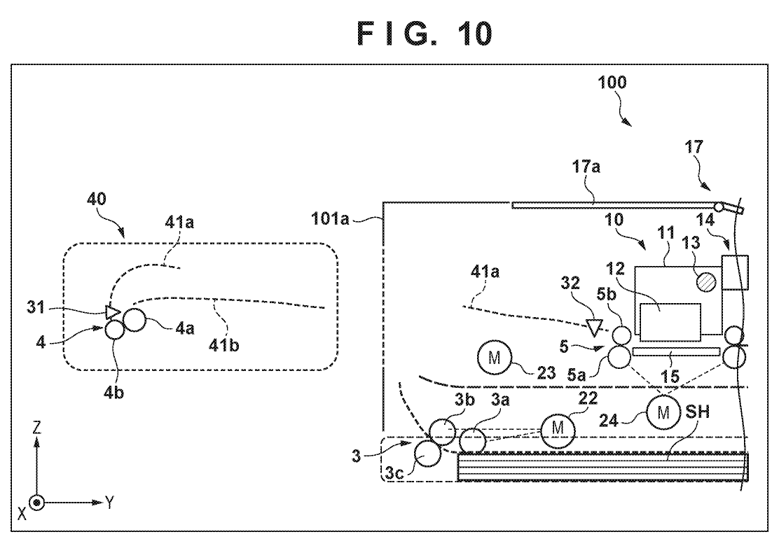

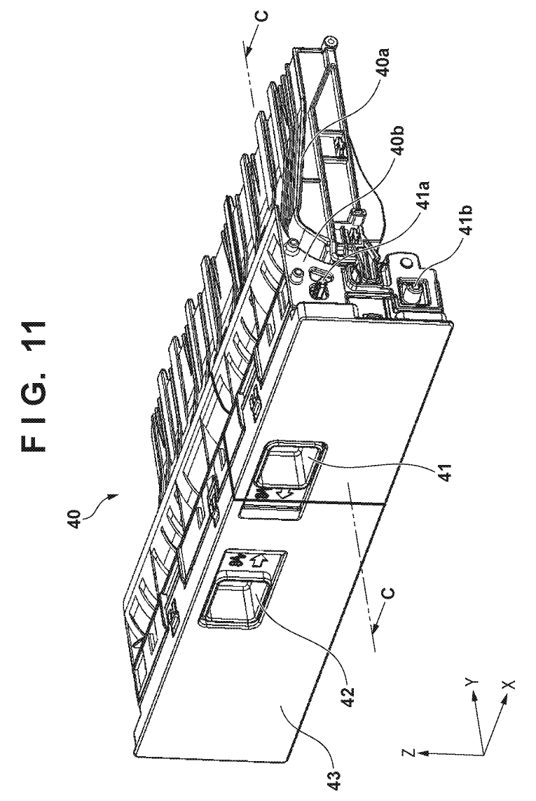

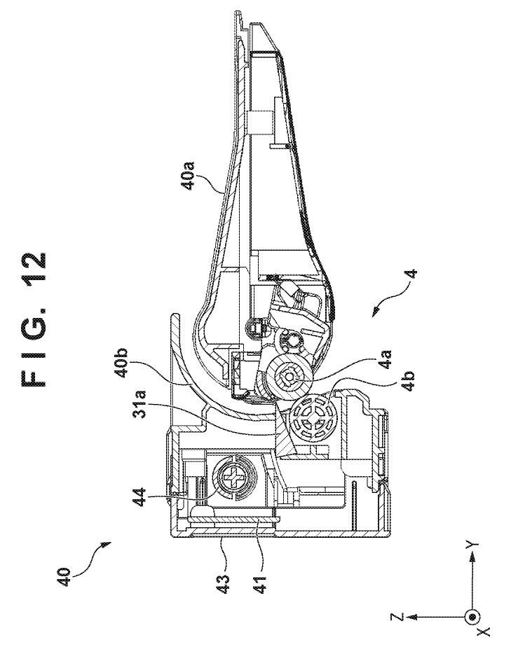

Maintenance around the attaching/detaching unit 40 will be described with reference to FIGS. 10 to 12. FIG. 10 is a schematic view of the internal structure of the printing apparatus 1 in which the attaching/detaching unit 40 is detached, FIG. 11 is a perspective view of the attaching/detaching unit 40, and FIG. 12 is a sectional view taken along a line C - C in FIG. 11.

The attaching/detaching unit 40 is configured as a conveyance path unit that forms a portion including a partial path from the feeding unit 4 to the upstream portion of the conveying unit 5. Hence, if the sheet SH fed from the feeding unit 3 causes a jam on the upstream side of the conveying unit 5 in the main conveyance path RT1, it is possible to detach the attaching/detaching unit 40 from the main body 100 and handle the jam.

In the front surface of the attaching/detaching unit 40, grip portions 41 and 42 to be gripped by the operator when extracting the attaching/detaching unit 40 from the main body 100 are formed. A lock spring 44 is arranged between the left and right grip portions 41 and 42. In a state in which the grip portions 41 and 42 are not gripped, the grip portions 41 and 42 are biased in the left/right (X) direction. Bosses 41a and 41b are provided at an end portion of the biased grip portion 41 to position and lock with respect to the main body 100. Similarly, the grip portion 42 is provided with bosses (not shown) at an end portion and functions in a similar manner.

The attaching/detaching unit 40 is provided with a lever 31a for the sensor 31 on the downstream side of the feeding unit 4. The lever 31a can rotate about a shaft in the X direction, and its distal end projects into the main conveyance path RT1. The other end of the lever 31a functions as a flag that blocks the optical axis of a photo interrupter functioning as the sensor 31 arranged in the main body 100.

In the attaching/detaching unit 40, the feeding roller 4a and the driven roller 4b of the feeding unit 4 are supported. A part of the path forming members 40a and 40b is also supported. The path forming members 40a and 40b may further be separable. Instead of providing the path forming member 40a in the attaching/detaching unit 40, the path forming member 40a remaining in the main body 100 at the time of detachment of the attaching/detaching unit 40 may be detached.

### Second Embodiment

In the first embodiment, the opening portion 70 is formed in the upper surface of the housing 101, but the formation place of the opening portion is not limited to this.

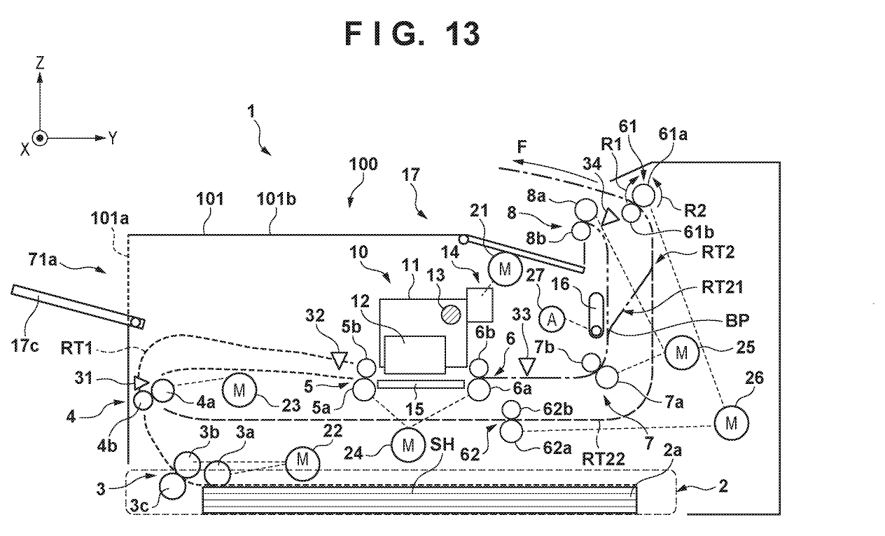

For example, like an example shown in FIG. 13, an opening portion 71a may be formed in a front surface 101a of the housing 101. The opening portion 71a is opened/closed by an opening/closing member 17c. The opening/closing member 17c is a movable member forming a part of the front surface 101a. Even with this configuration, the operator can access the periphery of a printhead 12 from the opening portion 71a.

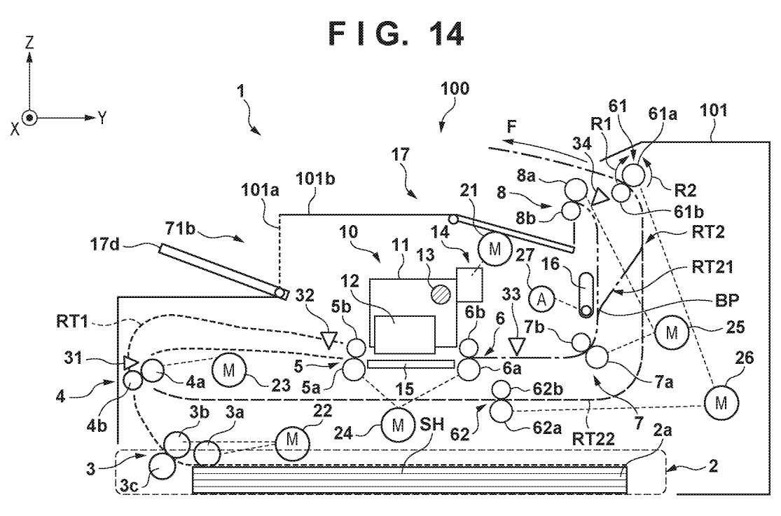

Also, like an example shown in FIG. 14, the front surface 101a may have a portion recessed to the far side in the Y direction, and an opening portion 71b may be formed here. The opening portion 71b is opened/closed by an opening/closing member 17d. Even with this configuration, the operator can access the periphery of the printhead 12 from the opening portion 71b.

### Third Embodiment

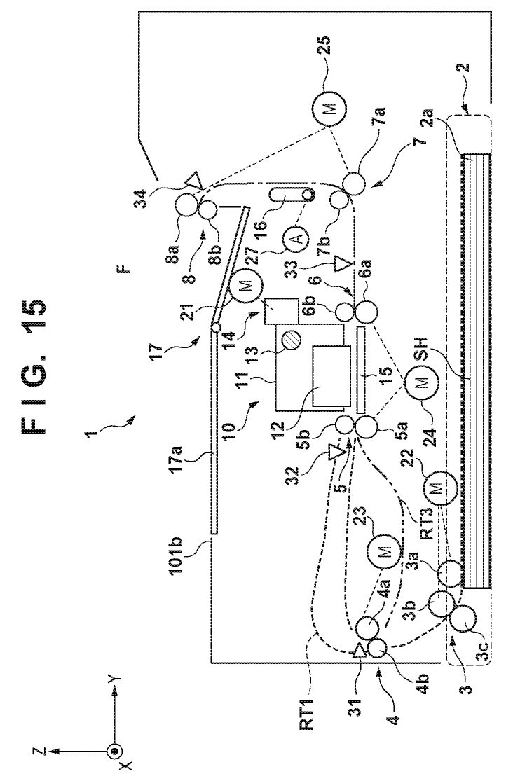

The path for inverting a sheet SH and conveying it to a printhead 12 for double-sided printing is not limited to that of the first embodiment. FIG. 15 shows an example of a printing apparatus 1 according to this embodiment, which includes a sub conveyance path RT3 in place of a sub conveyance path RT2. In this embodiment, after the first surface of the sheet SH is printed by the printhead 12, the rollers of conveying units 5 to 8 are rotated in reverse directions, thereby guiding the sheet SH to the sub conveyance path RT3. The sheet SH is inverted in the sub conveyance path RT3 and returned to a main conveyance path RT1 by a feeding unit 4. After that, the printing for the second surface of the sheet SH is performed by the printhead 12, and the sheet SH is discharged.

### Fourth Embodiment

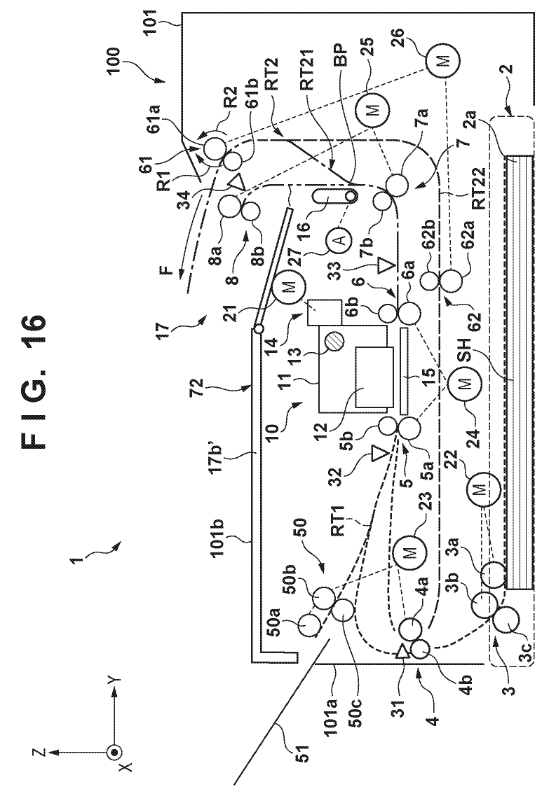

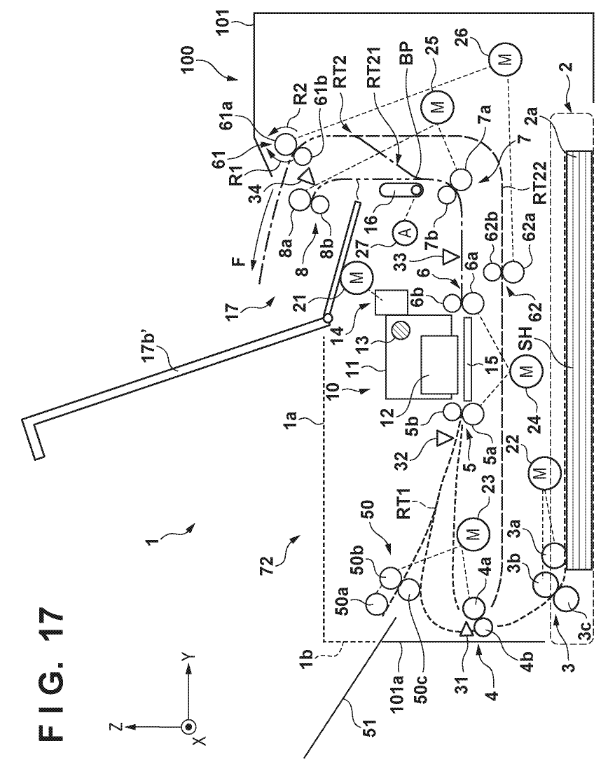

Another feeding tray for feeding a sheet SH may be provided. FIGS. 16 and 17 show an example. In this embodiment, a feeding tray 51 on which the sheet SH can be set from a front surface 101a of a printing apparatus 1 is provided, and a front feeding unit 50 is provided in correspondence with this.

The front feeding unit 50 includes a feeding roller 50a to be pressed against the sheet SH stacked on the feeding tray 51. A conveyance roller 50b and a separation roller 50c are provided on the downstream side of the feeding roller 50a. The feeding roller 50a and the conveyance roller 50b may have a dedicated driving source, or may use a feeding motor 22 as a driving source. The sheet SH set on the feeding tray 51 is picked up by the feeding roller 50a, separated one by one by the nip portion between the conveyance roller 50b and the separation roller 50c, and fed to a main conveyance path RT1. When not used, the feeding tray 51 may be folded such that it does not project from a main body 100.

In this embodiment, an opening/closing member 17b' replacing the opening/closing member 17b is extended up to the front surface 101a, and an opening portion 72 replacing the opening portion 70 exposes a range from a printhead 12 to the front feeding unit 50. FIG. 16 is a view showing the opening/closing member 17b' in a closed state, and FIG. 17 is a view showing the opening/closing member 17b' in an open state. When the opening/closing member 17b' is set in the open state, maintenance can be performed not only for the periphery of the printhead 12 but also for the periphery of the front feeding unit 50. Even if a jam of the sheet SH occurs near the front feeding unit 50, this can be handled.

Note that in this embodiment, a feeding tray 2a may be omitted, and the sheet SH may be fed only from the feeding tray 51.

### Fifth Embodiment

The above-described embodiments can be combined with each other. For example, a configuration obtained by combining the third embodiment and the fourth embodiment can be employed. An embodiment that removes some components from the above-described embodiments can also be employed.

### Sixth Embodiment

### Outline of Printing Apparatus

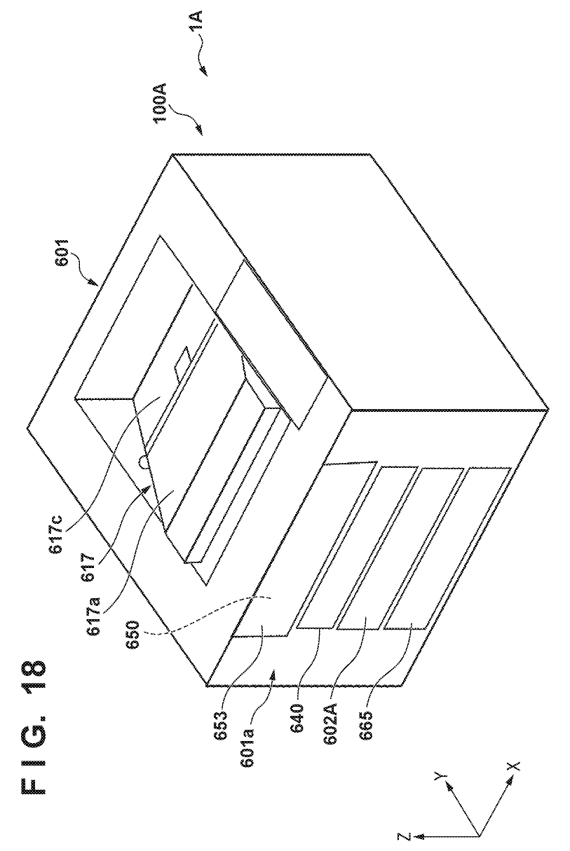

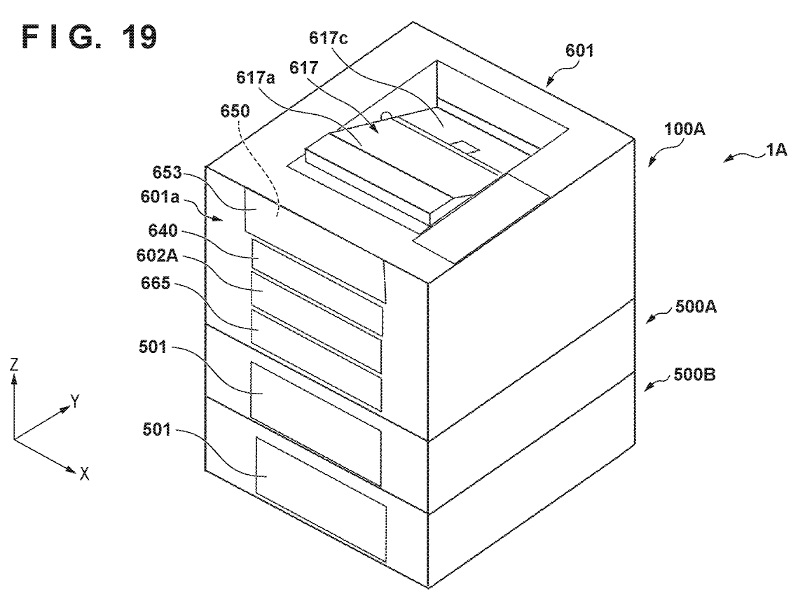

FIG. 18 is a view showing the outer appearance of a printing apparatus 1A according to the embodiment. A plurality of optional devices can be attached to the printing apparatus 1A. FIG. 19 shows a mode in which optional devices 500A and 500B are attached to the printing apparatus 1A. The optional devices 500A and 500B are devices having the same configuration. When referring to the optional devices 500A and 500B collectively or without distinction, these will simply be referred to as optional devices 500. Each optional device 500 includes a storage cassette 501 that stores print media. By adding the optional devices 500, the storage amount of the print media to be used for printing or the types of print media to be used for printing can be increased. The storage cassette 501 is detachably attached to the main body of the optional device 500. In this embodiment, the storage cassette 501 is provided on the front surface of the optional device 500 such that it can be inserted/removed into/from the main body in the Y direction.

In the example shown in FIG. 19, two stages of optional devices 500 are provided under the printing apparatus 1A. However, only one optional device 500 can be attached to the printing apparatus 1A, or three or more stages of optional devices 500 can be attached to the printing apparatus 1A. In addition, the printing apparatus 1A can be used without attaching the optional device 500.

Note that in this embodiment, a case where the present disclosure is applied to a serial type inkjet printing apparatus will be described. However, the present disclosure can also be applied to a printing apparatus of another type.

In drawings to be explained in this embodiment, arrows X, Y, and Z indicate directions crossing each other. The arrows X and Y indicate horizontal directions that are orthogonal to each other, and the arrow Z indicates the up/down direction. The X direction corresponds to the left/right direction (the widthwise direction) of the printing apparatus 1A, and the Y direction corresponds to the front/rear direction (the depth direction) of the printing apparatus 1A. The Z direction corresponds to the height direction of the printing apparatus 1A. Also, the downstream side and the upstream side are defined based on the conveyance direction of a print medium as a reference.

The printing apparatus 1A includes a main body 100A, an attaching/detaching unit 640 detachable from the main body 100A, a storage cassette 602A, and a tank unit 665. The main body 100A includes a housing 601 having a substantially rectangular parallelepiped shape, and the housing 601 forms the outer wall of the printing apparatus 1A. The attaching/detaching unit 640, the storage cassette 602A, and the tank unit 665 are attached to a front surface 601a of the housing 601, which forms the front portion of the printing apparatus 1A, such that these can be inserted/removed into/from the main body 100A in the Y direction. The front surface 601a is also provided with a cover 653 that can be opened/closed and cover a feeding unit 650 inside the main body 100A. The cover 653, the attaching/detaching unit 640, the storage cassette 602A, and the tank unit 665 are arranged in this order from above in the Z direction.

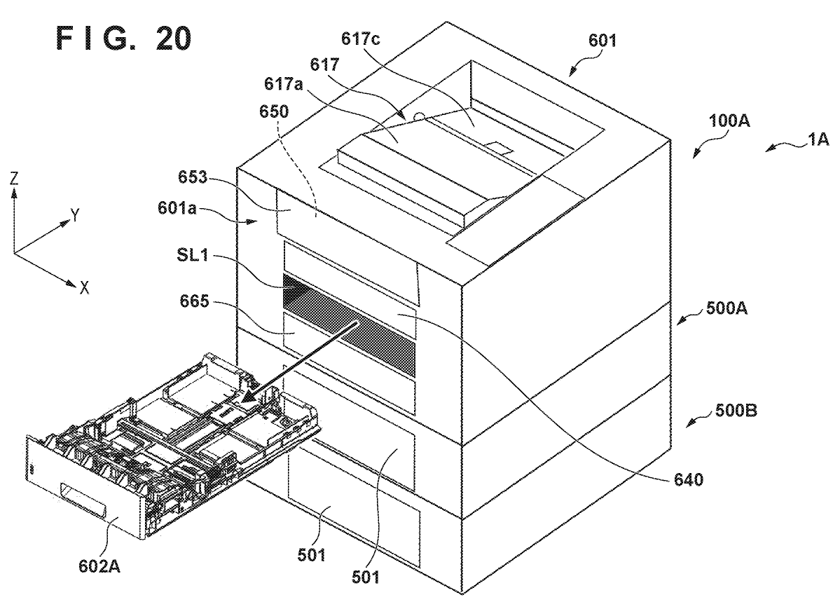

FIG. 20 shows a state in which the storage cassette 602A is extracted from the main body 100A in the -Y direction. The main body 100A has a slot SL1 that opens to the front surface 601a, and the storage cassette 602A is stored in the slot SL1.

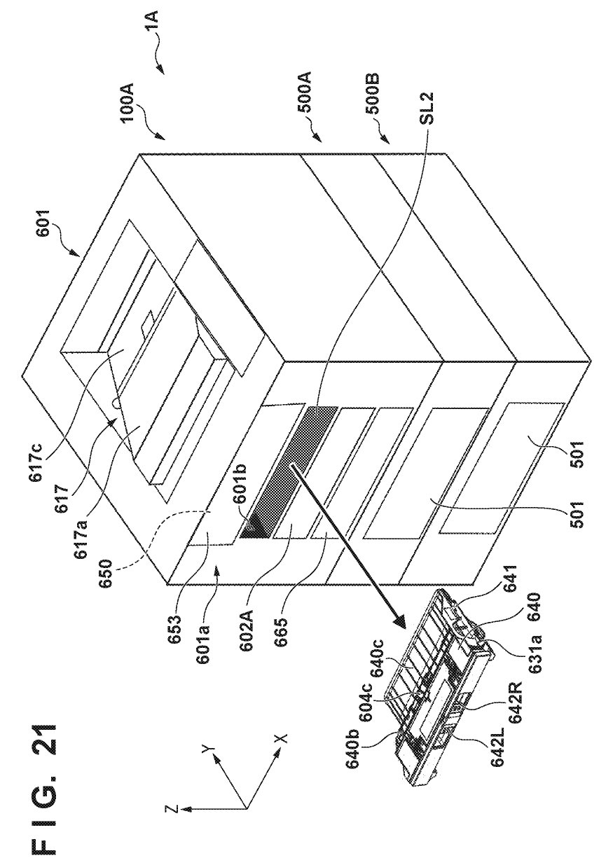

FIG. 21 is a view showing a state in which the attaching/detaching unit 640 is detached from the main body 100A in the -Y direction. The main body 100A has a slot SL2 opening to the front surface 601a, and the attaching/detaching unit 640 is stored in the slot SL2.

Although not particularly shown, the tank unit 665 is also stored in a slot provided in the main body 100A, like the storage cassette 602A and the attaching/detaching unit 640.

A discharge tray 617 is provided on the upper surface portion of the main body 100A. A printed print medium is discharged to the discharge tray 617 and stacked on the discharge tray 617.

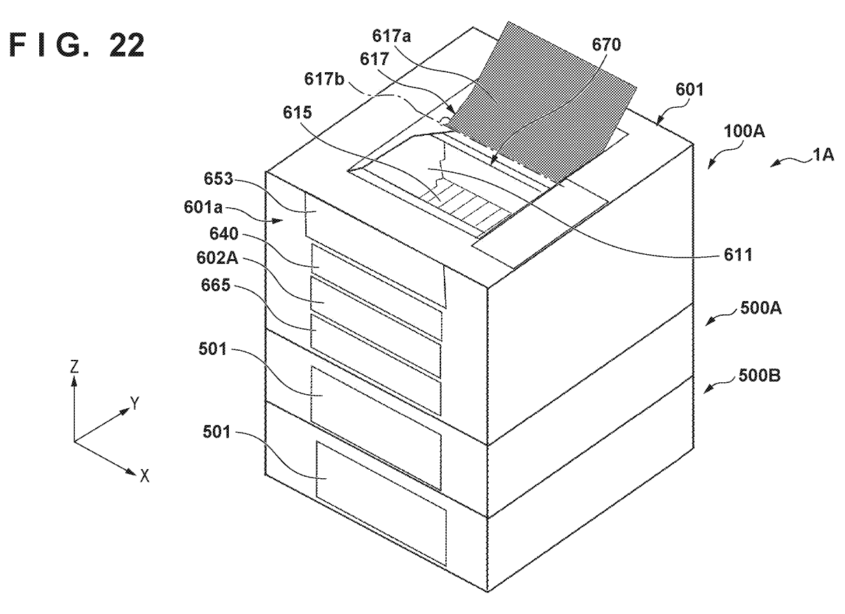

An opening portion 670 that is formed in the upper surface portion of the housing 601 and exposes the inside of the main body 100A of the printing apparatus 1A will be described with reference to FIGS. 19 and 22. The opening portion 670 is opened/closed by an opening/closing member 617a. In this embodiment, the opening/closing member 617a is a plate-shaped tray member that forms a part of the discharge tray 617, and is a rotation member provided to be rotatable about a rotation center axis 617b in the X direction. FIG. 22 shows a state in which the opening/closing member 617a is in an open state and the opening portion 670 is open. When the opening/closing member 617a is set in a closed state, as shown in FIG. 19, the opening portion 670 is closed.

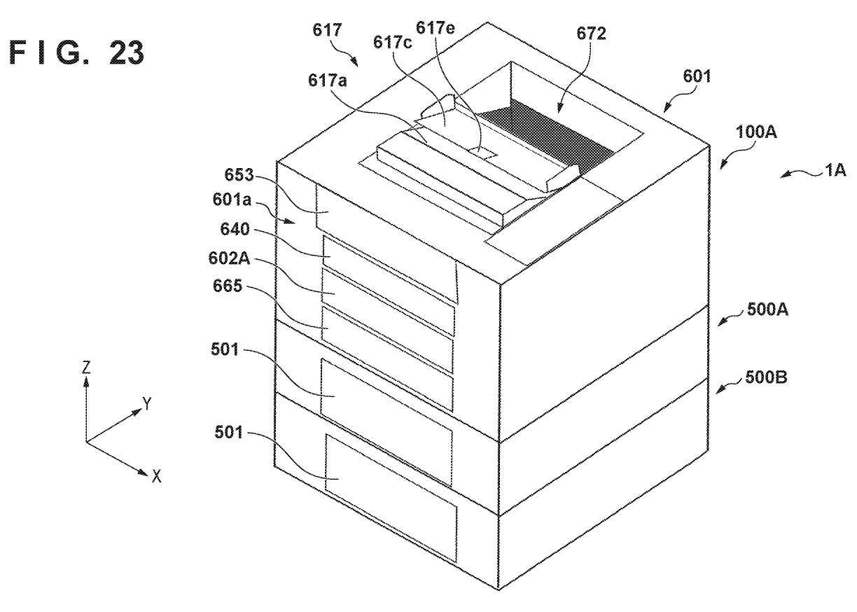

An opening portion 672 that is formed in the upper surface portion of the housing 601 and exposes the inside of the main body 100A of the printing apparatus 1A will be described with reference to FIGS. 19 and 23. The opening portion 672 is located on the far side in the Y direction with respect to the opening portion 670. The opening portion 672 is opened/closed by an opening/closing member 617c. In this embodiment, the opening/closing member 617c is a plate-shaped tray member that forms a part of the discharge tray 617 together with the opening/closing member 617a, and is extracted to the near side. When extracting the opening/closing member 617c, an operator can operate by holding a grip portion 617e. FIG. 23 shows a state in which the opening/closing member 617c is in an open state and the opening portion 672 is open. When the opening/closing member 617c is set in a closed state, as shown in FIG. 19, the opening portion 672 is closed.

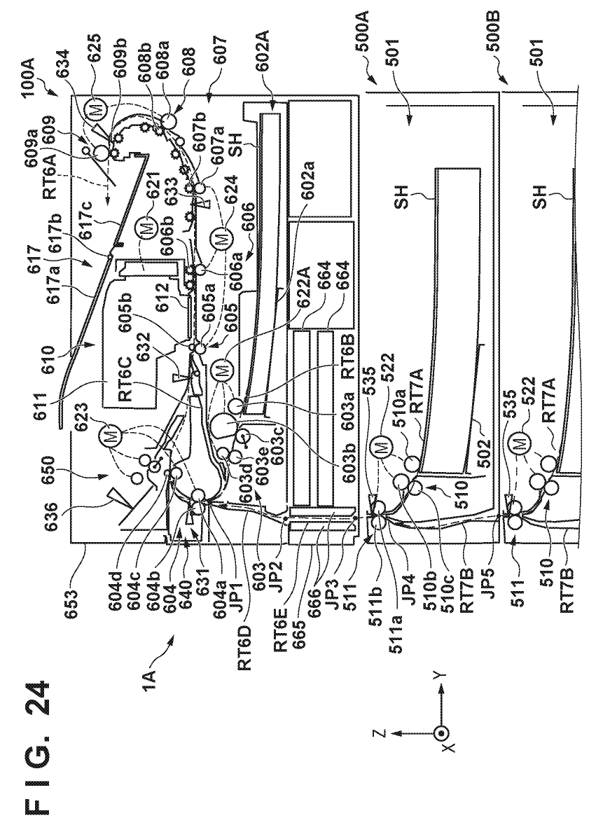

FIG. 24 is a schematic view of the internal structures of the printing apparatus 1A and the optional devices 500. The printing apparatus 1A performs printing on a sheet SH that is a print medium before printing stacked on a feeding tray 602a in the storage cassette 602A. In addition, the printing apparatus 1A discharges the printed sheet SH to the discharge tray 617. The storage cassette 602A can be detached from the main body 100A of the printing apparatus 1A, and the sheet SH can be set on the feeding tray 602a of the detached storage cassette 602A.

Also, the printing apparatus 1A performs printing on the sheet SH that is a print medium before printing stacked on a feeding tray 502 in each optional device 500. In addition, the printing apparatus 1A discharges the printed sheet SH to the discharge tray 617. A storage cassette 501 of each optional device 500 can be detached from the optional device 500, and the sheet SH can be set on the feeding tray 502 of the detached storage cassette 501.

### Conveyance Path

The conveyance path of the sheet SH will be described. The printing apparatus 1A includes conveyance paths RT6A to RT6E that guide the conveyance of the sheet SH. The conveyance path RT6A is a main conveyance path formed from a joining point JP1 to the discharge tray 617. The conveyance path RT6B is formed from the feeding tray 602a to the joining point JP1. When printing the sheet SH stored in the storage cassette 602A, the sheet SH is conveyed in the order of conveyance path RT6B → conveyance path RT6A, and printing is performed in the process of conveyance.

The conveyance paths RT6D and RT6E are conveyance paths configured to feed the sheet SH from the optional device 500. The conveyance path RT6D is formed in the Z direction at the front portion of the storage cassette 602A. When the storage cassette 602A is attached to the main body 100A, the conveyance path RT6D is formed from an intermediate point JP2 to the joining point JP1. The conveyance path RT6E is formed in the Z direction at the front portion of the tank unit 665. When the tank unit 665 is attached to the main body 100A, the conveyance path RT6E is formed from an intermediate point JP3 to the intermediate point JP2.

Each optional device 500 includes conveyance paths RT7A and RT7B that guide the conveyance of the sheet SH. The conveyance path RT7A is a conveyance path formed from the feeding tray 502 to a joining point JP4 in the storage cassette 501 and configured to feed the sheet SH in the optional device 500. The conveyance path RT7B is formed at the front portion of the storage cassette 501 from an intermediate point JP5 to the joining point JP4. The conveyance path RT7B is a conveyance path configured to pass the sheet SH fed from another optional device 500 located on the lower side of the optional device 500. For example, in the example shown in FIG. 24, the conveyance path RT7B of the optional device 500A is a path configured to pass, through the optional device 500A, the sheet SH fed from the optional device 500B.

When printing the sheet SH stored in the optional device 500A, the sheet SH is conveyed in the order of conveyance path RT7A of optional device 500A → conveyance path RT6E of printing apparatus 1A → conveyance path RT6D → conveyance path RT6A, and printing is performed in the process of conveyance.

When printing the sheet SH stored in the optional device 500B, the sheet SH is conveyed in the order of conveyance path RT7A of optional device 500B → conveyance path RT7B of optional device 500A → conveyance path RT6E of printing apparatus 1A → conveyance path RT6D → conveyance path RT6A, and printing is performed in the process of conveyance.

A path configured to invert the sheet SH and convey it to a printhead 612 for double-sided printing will be described next. In this embodiment, after the first surface of the sheet SH is printed by the printhead 612, the sheet SH is conveyed to the conveyance path RT6C, thereby inverting the sheet SH. The conveyance path RT6C is a sub conveyance path formed from the vicinity of a conveying unit 605 to be described later to the joining point JP1. It is possible to invert the sheet SH with the printed first surface via the conveyance path RT6C and introduce it into the conveyance path RT6A. Then, printing can be performed for the second surface of the sheet SH.

Introduction of the sheet SH into the conveyance path RT6C is performed in the following way. After the trailing edge of the sheet SH reaches the vicinity of the conveying unit 605 to be described later or exits from the conveying unit 605, the rollers of at least some of the conveying units 605 to 609 to be described later are rotated reversely. The sheet SH with the printed first surface can thus be introduced into the conveyance path RT6C. The sheet SH with the printed second surface is discharged to the discharge tray 617.

Note that each conveyance path is formed by path forming members. As an example of the path forming members, FIG. 24 schematically shows a pair of path forming members 666 that form the conveyance path RT6E. The pair of path forming members 666 are arranged to face each other in the Y direction, and the conveyance path RT6E extending in the Z direction is formed between these. Each conveyance path is defined by such path forming members.

### Conveyance Mechanism

A configuration for conveying the sheet SH will be described next. The printing apparatus 1A includes a feeding unit 603, a feeding unit 604, and the plurality of conveying units 605 to 609. The feeding unit 603, the feeding unit 604, and the conveying units 605 to 609 are arranged in this order from the upstream side to the downstream side in the conveyance direction of the sheet SH in the conveyance path RT6B and the conveyance path RT6A. Image formation (printing) for the sheet SH is performed by a printing unit 610 between the conveying unit 605 and the conveying unit 606.

### Feeding Unit 603

The sheet SH on the feeding tray 602a is introduced into the conveyance path RT6B and the conveyance path RT6A one by one by the feeding unit 603. The feeding unit 603 is a pickup mechanism that picks up the sheet SH from the feeding tray 602a using a feeding motor 622A as a driving source. The feeding unit 603 includes a feeding roller (pickup roller) 603a, a feeding roller 603b, a separation roller 603c, a feeding roller 603d, and a driven roller 603e that forms a nip with the feeding roller 603d.

The feeding roller 603a contacts the uppermost surface of the sheet SH stacked on the feeding tray 602a and is rotated by the driving force of the feeding motor 622A, thereby starting feeding the sheet SH. The feeding roller 603b that is rotated by the driving force of the feeding motor 622A and the separation roller 603c that forms a nip portion with the feeding roller 603b are arranged on the downstream side of the feeding roller 603a. The separation roller 603c is a roller that includes a torque limiter and has a rotational resistance. If two or more sheets SH enter the nip portion between the feeding roller 603b and the separation roller 603c, the sheet SH is separated one by one by the rotational resistance of the separation roller 603c.

The separated sheet SH is conveyed to the feeding roller 603d and the driven roller 603e on the downstream side. The feeding roller 603d uses the feeding motor 622A as the driving source.

### Feeding Unit 604

The feeding unit 604 conveys the sheet SH introduced from the joining point JP1 into the conveyance path RT6A to the conveying unit 605. The feeding unit 604 includes feeding rollers 604a and 604c. The feeding rollers 604a and 604c are rotating bodies that are rotated by the driving force of a feeding motor 623. The feeding rollers 604a and 604c are in pressure contact with corresponding driven rollers 604b and 604d to form nip portions. The driven rollers 604b and 604d are rotating bodies following the rotation of the feeding rollers 604a and 604c.

The sheet SH is clamped in the nip portion between the feeding roller 604a and the driven roller 604b and the nip portion between the feeding roller 604c and the driven roller 604d and conveyed by the rotation of these.

Note that the feeding rollers 603a, 603b, and 603d are one-way rollers. For this reason, after the leading edge of the sheet SH is conveyed to a position beyond the nip portion of the feeding unit 604, the conveyance can be continued by the feeding unit 604 even if the driving of the feeding unit 603 is stopped.

The sensor 631 is a sensor that detects the sheet SH, and is a sensor that detects passage of the leading edge and the trailing edge of the sheet SH. The detection position of the sensor 631 is set to a position on the downstream side of the nip portion of the feeding unit 604. After passage of the leading edge of the sheet SH is detected, the detection result of the sensor 631 can be used as a trigger for conveyance control to, for example, stop driving of the feeding unit 603 or increase the conveyance speed of the feeding unit 604.

Also, using the sensor 631, the size of the sheet SH can be detected based on the driving amounts of the motor 623 and a motor 624 from detection of the leading edge of the sheet SH to detection of the trailing edge, and subsequent conveyance control can be switched.

### Conveying Unit 605

The conveying unit 605 is arranged on the upstream side of the printhead 612. The conveying unit 605 conveys the sheet SH to the downstream side between the printhead 612 and a platen 615 facing the printhead 612. The conveying unit 605 includes a conveyance roller 605a, and a driven roller (pinch roller) 605b brought into pressure contact with the conveyance roller 605a by a spring (not shown) or the like. The conveyance roller 605a is a rotating body that is rotated by the driving force of the conveyance motor 624, and the driven roller 605b is a rotating body that rotates following the rotation of the conveyance roller 605a. The sheet SH is clamped in the nip portion between the conveyance roller 605a and the driven roller 605b, and conveyed by the rotation of the conveyance roller 605a and the driven roller 605b.

A sensor 632 is a sensor that detects the sheet SH, and is a sensor that detects passage of the leading edge and the trailing edge of the sheet SH, like the sensor 631. The sensor 632 is, for example, an optical sensor. Since the sensor 632 is arranged on the upstream side near the conveying unit 605, the detection result can be used to manage the loop amount of registration of the sheet SH or the positions of the leading edge and the trailing edge of the sheet SH.

### Conveying Unit 606

The conveying unit 606 is arranged on the downstream side of the printhead 612 and conveys the sheet SH conveyed by the conveying unit 605 up to the conveying unit 609 on the downstream side. The conveying unit 606 includes a conveyance roller 606a, and a spur 606b that is brought into pressure contact with the conveyance roller 606a by a spring (not shown) or the like. The conveyance roller 606a is a rotating body that is rotated by the driving force of the conveyance motor 624, and the spur 606b is a rotating body that rotates following the rotation of the conveyance roller 606a. In this embodiment, the conveying unit 605 and the conveying unit 606 share the driving source (conveyance motor 624).

### Conveying Unit 607

The conveying unit 607 is arranged on the downstream side of the printhead 612 and the conveying unit 606 and conveys the sheet SH conveyed by the conveying unit 606 to the downstream side. The conveying unit 607 includes a conveyance roller 607a, and a spur 607b that is brought into pressure contact with the conveyance roller 607a by a spring (not shown) or the like. The conveyance roller 607a is a rotating body that is rotated by the driving force of the conveyance motor 624, and the spur 607b is a rotating body that rotates following the rotation of the conveyance roller 607a. The sheet SH is clamped in the nip portion between the conveyance roller 607a and the spur 607b and conveyed by the rotation of the conveyance roller 607a and the spur 607b.

A sensor 633 is, for example, an optical sensor and detects the sheet SH, like the sensors 631 and 632. The sensor 633 can be used to detect the leading edge and the trailing edge of the sheet SH or detect the presence/absence of the sheet SH in the conveyance path if a jam of the sheet SH occurs in the conveyance path.

### Conveying Units 608 and 609

The conveying units 608 and 609 are arranged on the downstream side of the printhead 612 and the conveying units 606 and 607. The conveying units 608 and 609 are discharging units that discharge the sheet SH conveyed by the conveying unit 607 to the discharge tray 617. In single-sided printing, the sheet SH discharged to the discharge tray 617 is so-called "face-down discharge" in which an image printed surface faces down. In double-sided printing, the second surface faces down.

The conveying unit 608 includes a conveyance roller 608a, and a spur 608b that is brought into pressure contact with the conveyance roller 608a by a spring (not shown) or the like. The conveyance roller 608a is a rotating body that is rotated by the driving force of a conveyance motor 625, and the spur 608b is a rotating body that rotates following the rotation of the conveyance roller 608a. The sheet SH is clamped in the nip portion between the conveyance roller 608a and the spur 608b and conveyed by the rotation of the conveyance roller 608a and the spur 608b.

The conveying unit 609 includes a conveyance roller 609a, and a spur 609b that is brought into pressure contact with the conveyance roller 609a by a spring (not shown) or the like. The conveyance roller 609a is a rotating body that is rotated by the driving force of the same conveyance motor 625 as that for the conveying unit 608, and the spur 609b is a rotating body that rotates following the rotation of the conveyance roller 609a. The sheet SH is clamped in the nip portion between the conveyance roller 609a and the spur 609b and conveyed by the rotation of the conveyance roller 609a and the spur 609b.

In this embodiment, the conveying unit 608 and the conveying unit 609 share the driving source (conveyance motor 625). However, the conveyance motor 625 may be eliminated, and the conveyance motor 624 that is the driving source for the conveying units 605 to 607 may be shared by the conveying unit 608 and the conveying unit 609 as well.

Also, in this embodiment, four conveying units (conveying units 606 to 609) are used on the downstream side of the printhead 612. However, the number of conveying units may be decreased in accordance with the conveyance-direction size of the corresponding print medium of the printing apparatus 1A. For example, only the conveying unit 606 and the conveying unit 609 may be left, and the conveying unit 609 may discharge the sheet SH to the discharge tray 617.

A sensor 634 is a sensor that detects the sheet SH, and is a sensor that detects passage of the leading edge and the trailing edge of the sheet SH, like the sensors 631 to 633. The sensor 634 is, for example, an optical sensor. In this embodiment, after the trailing edge of the sheet SH is detected by the sensor 634, discharge is completed (the trailing edge of the sheet SH reaches the discharge tray 617) after a predetermined conveyance amount. Hence, the detection result of the sensor 634 can be used to detect discharge of the sheet SH.

The conveyance mechanism of the sheet SH provided in the optional device 500 will be described next. The sheet SH set on the feeding tray 502 is separated one by one by a feeding unit 510 in the optional device 500 and fed to the conveyance path RT7A. The feeding unit 510 is a pickup mechanism that picks up the sheet SH from the feeding tray 502 using a feeding motor 522 as a driving source. The feeding unit 510 includes a feeding roller (pickup roller) 510a, a feeding roller 510b, and a separation roller 510c.

A feeding unit 511 is located on the downstream side of the feeding unit 510, and includes a feeding roller 511a and a driven roller 511b. The feeding roller 511a is a rotating body that is rotated by the driving force of the feeding motor 522, and the driven roller 511b is a rotating body that rotates following the rotation of the feeding roller 511a.

The sheet SH is clamped in the nip portion between the feeding roller 511a and the driven roller 511b and conveyed by the rotation of the feeding roller 511a and the driven roller 511b.

The sheet SH conveyed by the feeding unit 511 of the optional device 500A passes through the top face side outlet of the optional device 500A and the intermediate point JP3 that is the conveyance path inlet on the bottom surface of the printing apparatus 1A and enters the conveyance path RT6E. The sheet SH is further conveyed to the joining point JP1 through the conveyance path RT6D.

The sheet SH conveyed by the feeding unit 511 of the optional device 500B passes through the top face side outlet of the optional device 500B and the intermediate point JP5 that is the conveyance path inlet on the bottom surface of the optional device 500A and enters the conveyance path RT7B. The sheet SH further passes through the conveyance path RT7B of the optional device 500A and is conveyed to the joining point JP1 through the conveyance path RT6D by the feeding unit 511 of the optional device 500A.

### Printing Unit

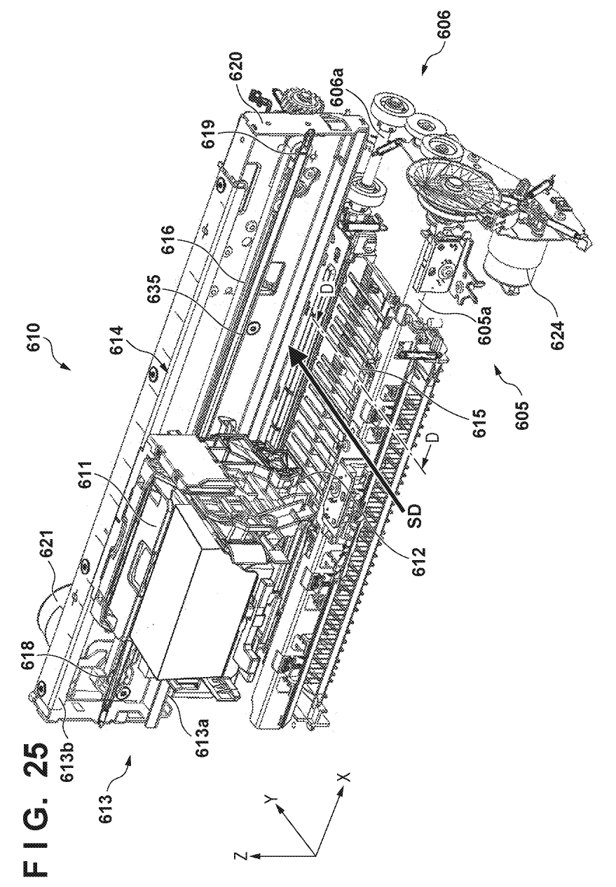

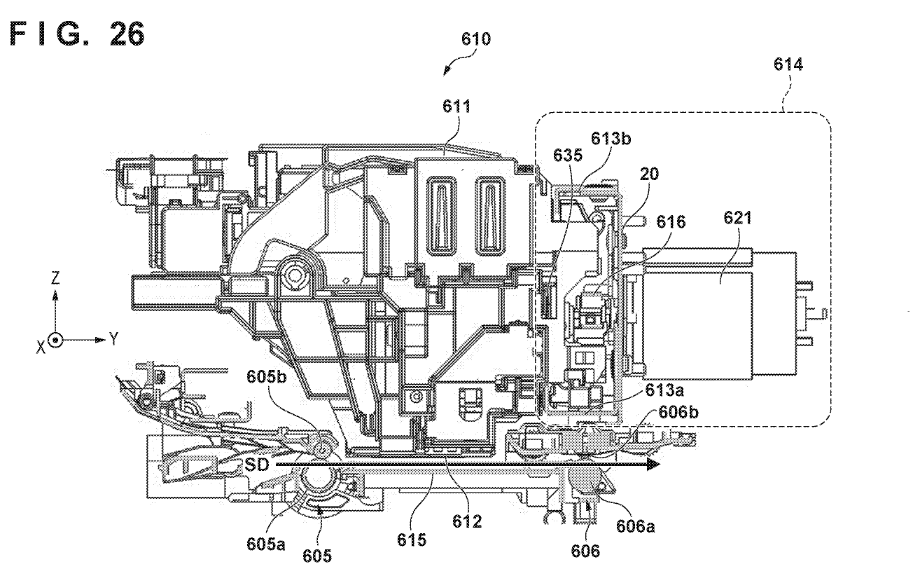

The printing unit 610 according to this embodiment will be described with reference to FIGS. 25 and 26 in addition to FIG. 24. FIG. 25 is a perspective view of the printing unit 610, and FIG. 26 is a sectional view taken along a line D - D in FIG. 24. The printing unit 610 includes the printhead 612, a carriage 611, and a driving unit 614. The printhead 612 discharges liquid ink to the sheet SH, thereby printing an image on the sheet SH. The lower surface of the printhead 612 forms a discharge surface in which a plurality of nozzles for discharging ink are formed.

The ink to be supplied to the printhead 612 is stored in an ink tank 664 of the tank unit 665. The ink stored in the ink tank 664 is supplied to the printhead 612 via a tube (not shown) (tube supply method). Note that as for the ink supply method, there also exist an independent ink cartridge method in which the ink cartridge is mounted on the carriage 611 together with the printhead 612 and a head cartridge method in which the ink cartridge and the printhead 612 are integrated, and any method can be used.

The platen 615 is arranged to face the printhead 612 (particularly, the discharge surface) between the conveying unit 605 and the conveying unit 606. The sheet SH is conveyed in a direction of an arrow SD (+Y direction) between the printhead 612 and the platen 615, and the printhead 612 prints an image.

The printhead 612 is mounted on the carriage 611. The carriage 611 is reciprocally moved in a direction (in this embodiment, the X-axis direction) crossing the direction SD by the driving unit 614.

The driving unit 614 includes a support member 620 extended in the X-axis direction. The support member 620 is a base member that supports the components of the driving unit 614. The support member 620 is provided with a guide member 613 that engages with the carriage 611 and guides the movement of the carriage 611. In this embodiment, the guide member 613 includes a rail member 613a on the lower side and a rail member 613b on the upper side. The rail members 613a and 613b are apart in the Z-axis direction and are extended in the X-axis direction. The rail members 613a and 613b engage with the carriage 611 and guide the movement of the carriage 611. Note that the guide member 613 may be a member having a shaft form.

The rail member 613a supports the carriage 611 in the height (Z) direction and the front/rear (Y) direction. When the height (Z) of the rail member 613a is adjusted with respect to the support member 620, the height (Z position) of the printhead 612 (particularly, the discharge surface) with respect to the platen 615 can be adjusted. The rail member 613b is located above (+Z direction) the rail member 613a, and regulates the position of the carriage 611 about the X-axis. When the rail member 613b is adjusted with respect to the support member 620 in the front/rear (Y) direction, the tilt of the printhead 612 about the X-axis with respect to the platen 615 can be adjusted.

The driving unit 614 according to this embodiment is a belt transmission mechanism using a carriage motor 621 as a driving source. However, the driving unit 614 may be of a mechanism type other than the belt transmission mechanism. The carriage motor 621 is arranged on the opposite side of the carriage 611 in the front/rear (Y) direction across the support member 620. The driving unit 614 includes a driving pulley 618 and a driven pulley 619, which are apart in the X-axis direction, and an endless belt 616 wound around these pulleys. These are arranged between the rail member 613a and the rail member 613b in the height (Z) direction.

The carriage 611 is fixed to the endless belt 616. When the carriage motor 621 rotates the driving pulley 618, the endless belt 616 travels, and the carriage 611 moves. A cord strip 635 is supported by the support member 620. A sensor (not shown) that detects the slit of the cord strip 635 is provided on the carriage 611, and it is therefore possible to specify the position of the carriage 611 in the X-axis direction or adjust the speed based on the detection result of the sensor.

An electrical contact between the printhead 612 and a board (not shown) is provided on the carriage 611. The board (not shown) may be arranged on the downstream side (+Y direction) of the printhead 612 in the conveyance direction and between the carriage 611 and the support member 620.

An image printing operation will be described next. In the process of reciprocal movement of the carriage 611 in the X-axis direction, ink is discharged from the printhead 612 to the sheet SH, thereby printing an image. This operation is called print scanning. The printing operation is performed by alternately repeating a conveyance operation of intermittently conveying the sheet SH in the direction SD by the conveying unit 605 and print scanning.

### Front Feeding Mechanism

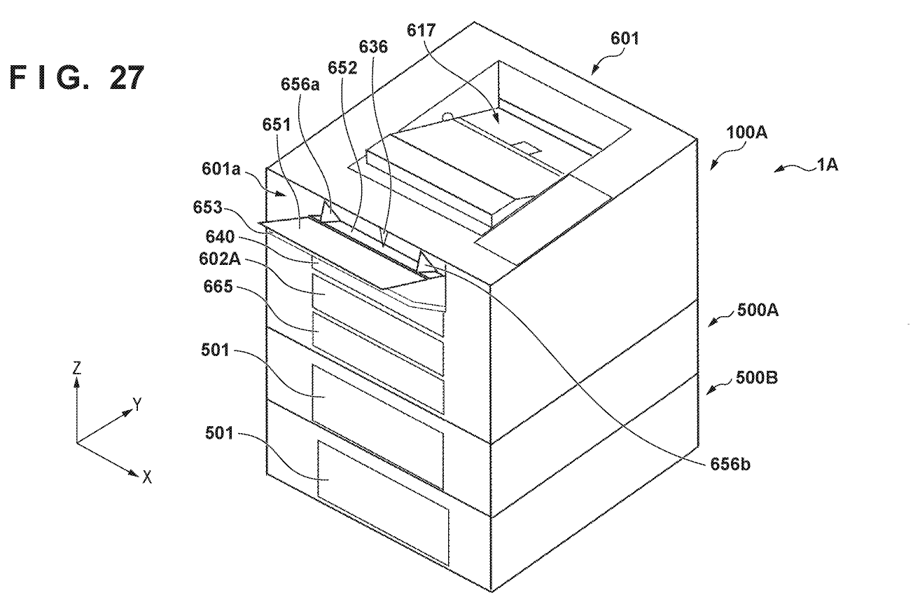

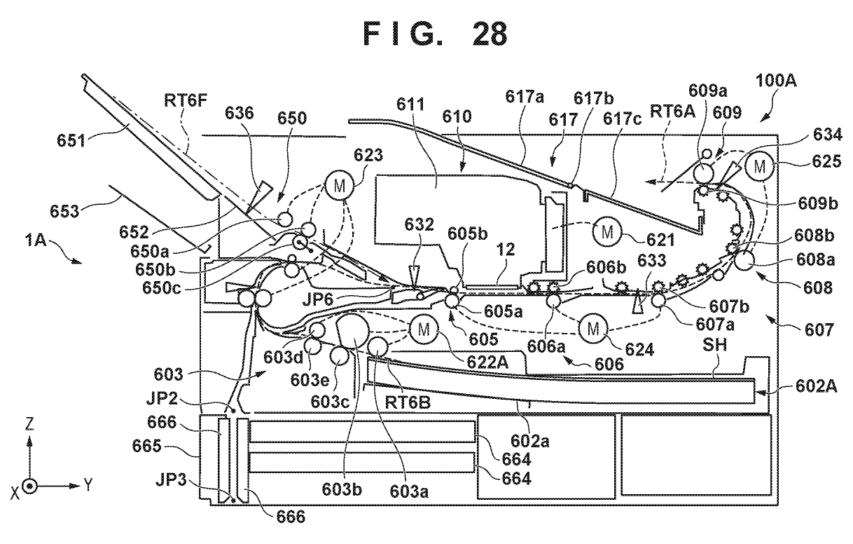

The front feeding mechanism of the printing apparatus 1A will be described with reference to FIGS. 27 and 28. By the front feeding mechanism, the sheet SH can manually be supplied from the front side of the printing apparatus 1A. FIG. 27 is a view showing a state in which the cover 653 and a stacking tray 651 are extracted from the state shown in FIG. 19. FIG. 28 is a schematic view of the internal structure of the printing apparatus 1A, and is a schematic view of a state in which the cover 653 and the stacking tray 651 are extracted.

In this embodiment, in addition to the already described storage cassette 602A, a feeding unit 650 is arranged on the upper side of the storage cassette 602A and the attaching/detaching unit 640 in the Z direction (+Z direction) and on the side of the front surface 601a of the printing apparatus 1A. FIG. 19 shows a state in which the stacking tray 651 is closed, and FIG. 27 shows a state in which the stacking tray 651 is opened. In the state in which the stacking tray 651 is closed, a plurality of trays are folded and stored inside. In the state in which the stacking tray 651 is open, the plurality of folded trays are unfolded to such a length that can hold the stacked sheet SH without dropping it.

A feeding tray 652 exists deep in the opened stacking tray 651, and the stacked sheet SH is held by both the stacking tray 651 and the feeding tray 652. There is provided a sensor 636 that detects whether the sheet SH is stacked on the feeding tray 652.

The sensor 636 is a sensor that detects the sheet SH, and is, for example, an optical sensor. The sensor 636 detects the presence/absence of the sheet SH on the feeding tray 652 and can also be formed by, for example, a reflection sensor. In addition, side guides 656a and 656b configured to support the stacked sheet SH in the widthwise direction are attached to the left and right sides of the feeding tray 652. The left and right side guides 656a and 656b are connected by a rack & pinion (not shown). If the user operates one of the side guides, the side guide on the opposite side moves in an interlocking manner, and the left and right edges of the sheet SH can be supported.

The arrangement of the feeding unit 650 and the conveyance path RT6F will be described next. The feeding unit 650 includes a feeding roller 650a to be pressed against the sheet SH stacked on the feeding tray 652. A conveyance roller 650b and a separation roller 650c are provided on the downstream side of the feeding roller 650a. The feeding roller 650a and the conveyance roller 650b are driven using the feeding motor 623 as a driving source. The sheet SH set on the feeding tray 652 is picked up by the feeding roller 650a, separated one by one by the nip portion between the conveyance roller 650b and the separation roller 650c, and fed to the conveyance path RT6A. The sheet SH fed from the feeding unit 650 joins the conveyance path RT6A at a joining point JP6, and is conveyed to the conveying unit 605. After that, the sheet SH is conveyed by the conveying unit 605, and an image is printed on it by the printhead 612.

### Layout of Components around Printhead

FIGS. 25 and 26 will be referred to. The sheet SH may cause a jam around the printhead 612. The driving unit 614 is a structure having the support member 620 fixed like a wall member on the X-Z plane. Depending on the arrangement of the driving unit 614, the driving unit 614 of the carriage 611 readily becomes an obstacle when considering the accessibility of the operator to the point of jam.

In this embodiment, the driving unit 614 is arranged on the downstream side (+Y direction) in the conveyance direction (direction SD) with respect to the printhead 612. The space on the upstream side of the printhead 612 is wide, and the accessibility of the operator to the upstream side of the printhead 612 is improved. As the form of a jam, the leading edge portion of the sheet SH is often jammed between the printhead 612 and the platen 615. Hence, since it is easy for the operator to work from the upstream side of the printhead 612, a recovery work can be performed more smoothly.

When viewed in the front/rear direction (Y direction) of the printing apparatus 1A, the conveying unit 605 is arranged on the front side (-Y direction side) with respect to the printhead 612, and the driving unit 614 is arranged on the rear side (+Y direction side) with respect to the printhead 612. As for the installation place of the printing apparatus 1A, in many cases, the space on the front side of the printing apparatus 1A is wide, and the space on the rear side is narrow due to the presence of a wall or the like. In this embodiment, the space on the front side of the printhead 612 is wide. Hence, if a jam occurs, the operator can easily perform the recovery work from the front side of the printing apparatus 1A.

Also, in this embodiment, the feeding unit 604 is arranged on the front side of the conveying unit 605. Even if a jam occurs between the feeding unit 604 and the conveying unit 605, the operator can easily perform the recovery work from the front surface 601a of the printing apparatus 1A.

### Structure Associated with Maintenance

### Maintenance around Printhead

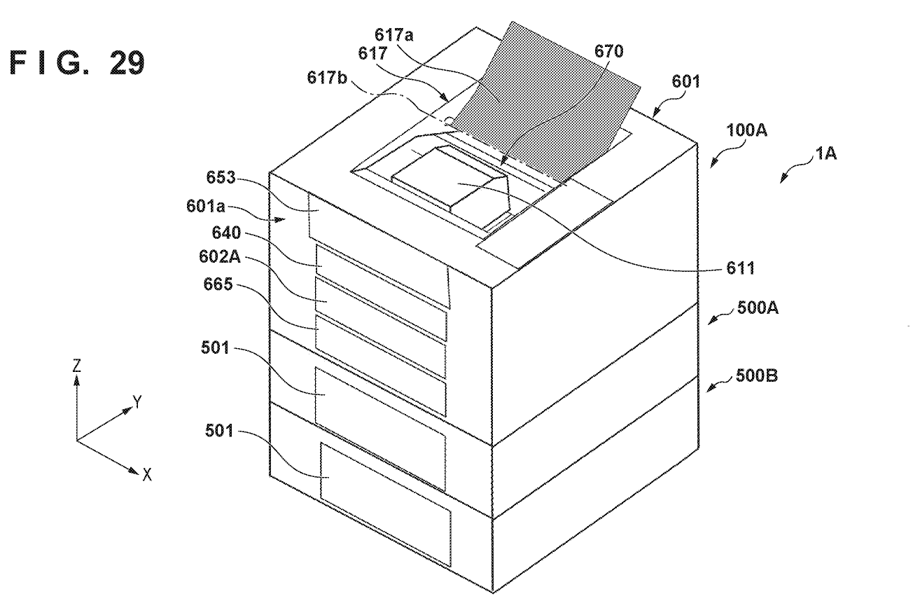

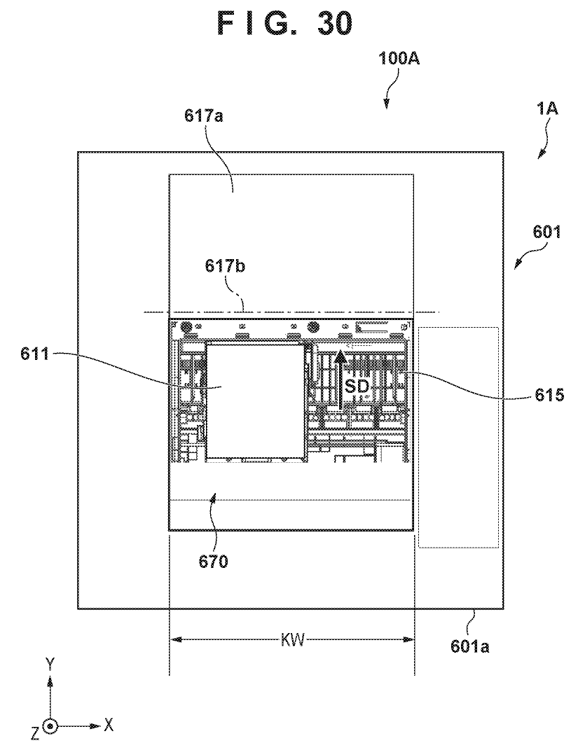

The printing apparatus 1A according to this embodiment has a structure that facilitates maintenance (access) to the printing unit 610. This will be described with reference to FIGS. 22, 23, 29, and 30. FIG. 29 is a view showing the outer appearance of the printing apparatus 1A in which the opening/closing member 617a is in the open state, and FIG. 30 is a plan view of the printing apparatus 1A in which the opening/closing member 617a is in the open state.

Examples of maintenance to the printing unit 610 are the above-described recovery of jam and exchange of the printhead 612.

Of the opening portion 670, a portion on the upstream side (-Y direction side) of the printhead 612 in the conveyance direction (direction SD) is formed to be exposed more than a portion on the downstream side (+Y direction side). The opening/closing member 617a is arranged on the upper side (+Z direction) of the conveying unit 605. If the opening/closing member 617a is set in the open state, the conveying unit 605, the carriage 611, the printhead 612, the platen 615, and the like are exposed via the opening portion 670, and the operator can access these. In this embodiment, since the driving unit 614 is arranged on the downstream side (+Y direction side) of the printhead 612 in the conveyance direction, the operator can easily access the conveying unit 605, the carriage 611, the printhead 612, the platen 615, and the like from the front side of the printing apparatus 1A.

As shown in FIG. 30, defining the width of the opening portion 670 in the X direction as KW, the width KW is larger than the maximum width of the sheets SH supported by the printing apparatus 1A. Hence, if the sheet SH causes a jam, the sheet SH can readily be removed from the opening portion 670.

### Structure of Attaching/Detaching Unit and Maintenance around It

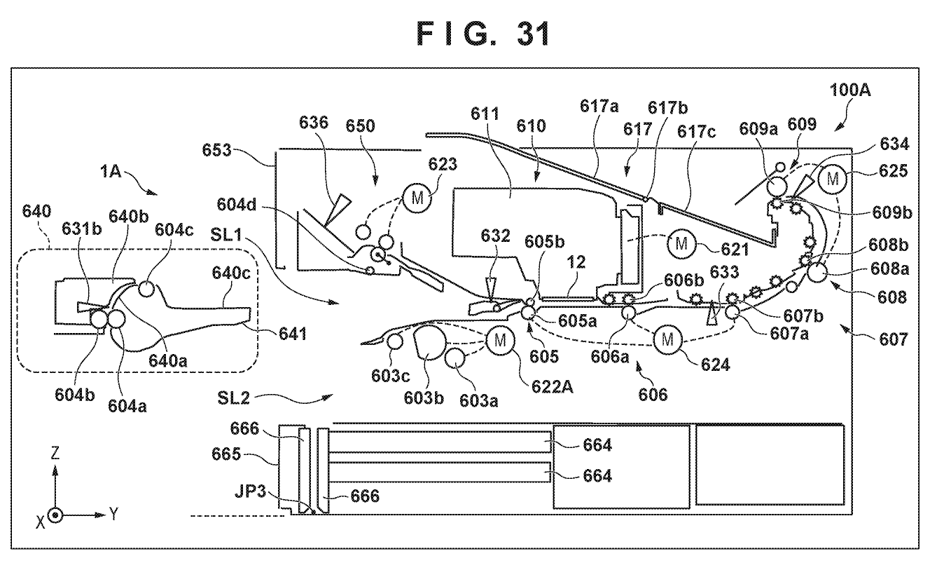

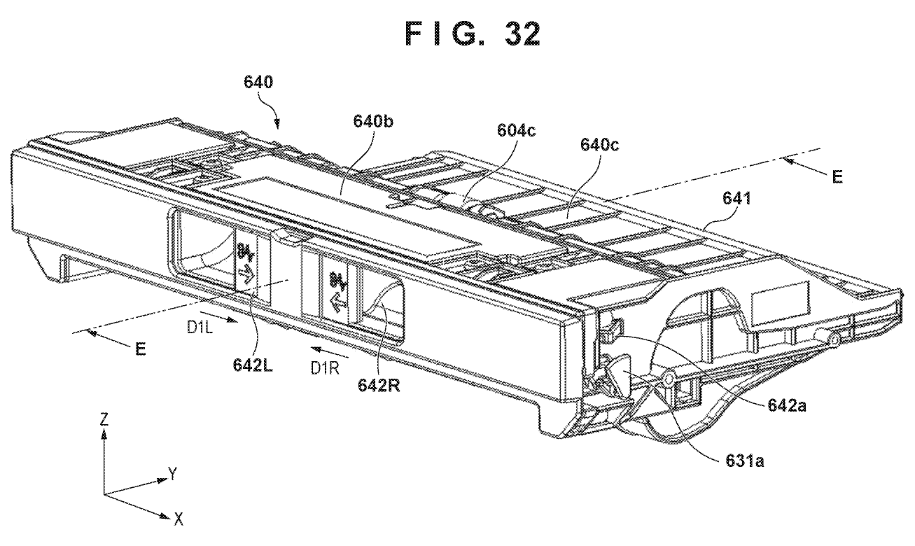

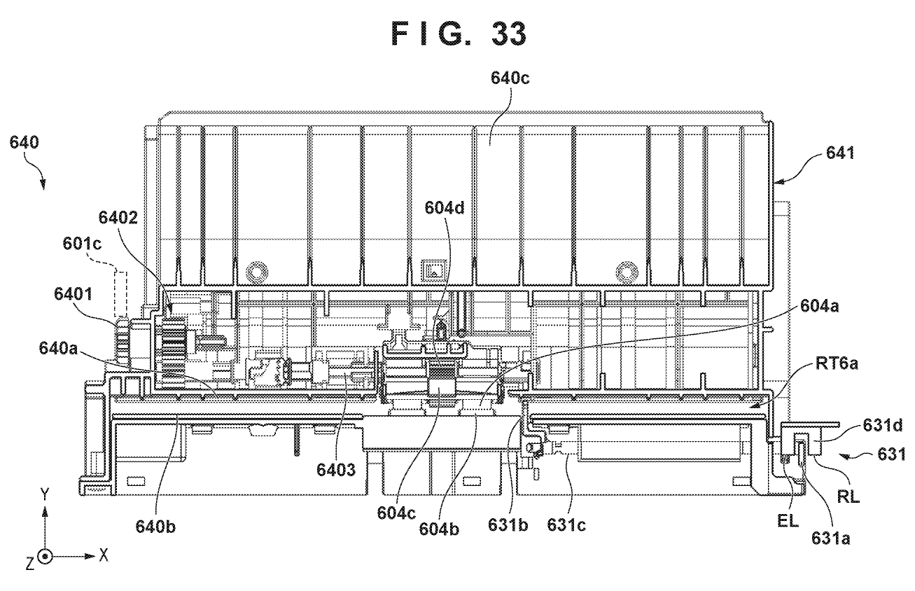

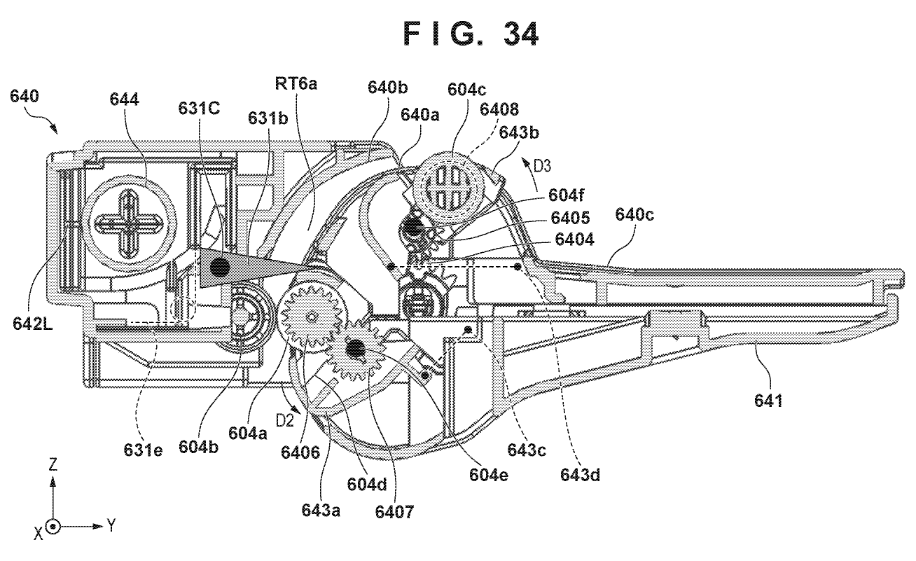

The structure of the attaching/detaching unit 640 and maintenance around it will be described. FIG. 31 is a schematic view of the internal structure of the printing apparatus 1A in which the attaching/detaching unit 640 is detached. FIG. 32 is a perspective view of the attaching/detaching unit 640. FIG. 33 is a plan view showing the internal structure of the attaching/detaching unit 640, showing some components in a see-through state and illustrating some components on the side of the main body 100A. FIG. 34 is a sectional view taken along a line E - E in FIG. 32.

The attaching/detaching unit 640 is configured as a conveyance path unit that forms a portion including a partial path from the feeding unit 604 to the upstream portion of the conveying unit 605. Hence, if the sheet SH fed from the feeding unit 603 causes a jam on the upstream side of the conveying unit 605 in the conveyance path RT6A, it is possible to detach the attaching/detaching unit 640 from the main body 100A and handle the jam, as exemplified in FIG. 31. Accessibility to the upstream side of the printhead 612 can be improved by detaching the attaching/detaching unit 640.

The attaching/detaching unit 640 includes a base portion 641, and slide members 642R and 642L arranged on the left and right sides are supported in the front portion of the base portion 641 such that these can freely slide in the X direction. The slide members 642R and 642L are operation portions (grip portions) to be operated by the operator when extracting the attaching/detaching unit 640 from the main body 100A.

When the operator slides the slide members 642R and 642L inward in the X direction (directions D1R and D1L in FIG. 32), engaging portions 642a connected to the slide members 642R and 642L are displaced inward in the X direction. FIG. 32 shows the engaging portion 642a connected to the slide member 642R, and the engaging portion 642a connected to the slide member 642L is not shown. The engaging portions 642a are located on the side portions of the attaching/detaching unit 640 in the left/right direction.

In a state in which the attaching/detaching unit 640 is attached to the main body 100A, the engaging portion 642a engages with an engaging portion 601b of the slot SL2 shown in FIG. 21. FIG. 21 shows the engaging portion 601b that engages with the engaging portion 642a of the slide member 642L. The engaging portion 601b is formed on each of the left and right inner walls of the slot SL2. When the operator slides the slide members 642R and 642L inward in the X direction, the engaging portion 642a and the engaging portion 601b are disengaged, and the attaching/detaching unit 640 can be detached from the main body 100A.

As shown in FIG. 34, a lock spring 644 is interposed between the right and left slide members 642R and 642L. The lock spring 644 biases the slide members 642R and 642L outward in the X direction. When the attaching/detaching unit 640 is inserted into the slot SL2 and the operator releases the hands from the slide members 642R and 642L, the engaging portion 642a and the engaging portion 601b engage with each other by the biasing of the lock spring 644. The attaching/detaching unit 640 is locked to the main body 100A.

The base portion 641 integrally includes path forming members 640a and 640b, which form a conveyance path RT6a that is a partial section of the conveyance path RT6A. The path forming members 640a and 640b are members having an arc-shaped cross section, which are extended in the X direction and are apart from each other in the Y direction. As shown in FIG. 34, the conveyance path RT6a extending in an arc shape in the Z direction when viewed in the X direction is formed between the path forming members 640a and 640b. The lower and upper ends of the conveyance path RT6a are opened. The base portion 641 also integrally includes a path forming member 640c continued from the path forming member 640a to the downstream side. The path forming member 640c forms the lower surface of a part of the conveyance path RT6A.

The attaching/detaching unit 640 includes a feeding roller 604a, and a driven roller 604b facing the feeding roller 604a. The driven roller 604b is rotatably supported by the base portion 641, and the feeding roller 604a is rotatably supported by a support member 643a.

The support member 643a is supported by the base portion 641 via a shaft 604e extended in the X direction and can rotate about the shaft 604e. The support member 643a is biased in a direction D2 by an elastic member 643c placed between the support member 643a and the base portion 641. For this reason, the feeding roller 604a that rotates integrally with the support member 643a is pressed against the driven roller 604b by the biasing of the elastic member 643c. In this embodiment, the elastic member 643c is a tension spring.

A driving force is transmitted to the feeding roller 604a via rotating bodies 6406 and 6407. In this embodiment, the rotating bodies 6406 and 6407 are gear devices. The rotating body 6406 is a spur gear that is provided on the same axis as the feeding roller 604a and rotates together with the feeding roller 604a. The rotating body 6407 is a spur gear that is provided on the same axis as the shaft 604e and rotates about the shaft 604e.

At the time of conveyance of the sheet SH, when the feeding roller 604a is driven, a revolving force is added to the support member 643a about the shaft 604e to the driven roller 604b, and the pressure contact force of the feeding roller 604a to the driven roller 604b becomes large. Hence, even if the biasing force of the elastic member 643c is small, a sufficient nip pressure can be obtained between the feeding roller 604a and the driven roller 604b in driving.

On the other hand, in a non-driving state of the feeding roller 604a, only the nip pressure by the biasing of the elastic member 643c acts. When detaching the attaching/detaching unit 640 from the main body 100A and handling a jam, even if the sheet SH is nipped between the feeding roller 604a and the driven roller 604b, the operator can more easily remove the sheet SH.

Also, in the attaching/detaching unit 640, the feeding roller 604c is provided. In the main body 100A, the driven roller 604d is provided at a position facing the feeding roller 604c. FIG. 33 shows the driven roller 604d as well.

The feeding roller 604c is rotatably supported by a support member 643b. The support member 643b is supported by the base portion 641 via a shaft 604f extended in the X direction and can rotate about the X axis with respect to the shaft 604f as the center. The support member 643b is biased in a direction D3 by an elastic member 643d placed between the support member 643b and the base portion 641. For this reason, the feeding roller 604c that rotates integrally with the support member 643b is pressed against the driven roller 604d by the biasing of the elastic member 643d. In this embodiment, the elastic member 643d is a tension spring.

A driving force is transmitted to the feeding roller 604c via rotating bodies 6405 and 6408. In this embodiment, the rotating bodies 6405 and 6408 are gear devices. The rotating body 6408 is a spur gear that is provided on the same axis as the feeding roller 604c and rotates together with the feeding roller 604c. The rotating body 6405 is a spur gear that is provided on the same axis as the shaft 604f and rotates about the shaft 604f.

At the time of conveyance of the sheet SH, when the feeding roller 604c is driven, a revolving force is added to the support member 643b about the shaft 604f to the driven roller 604d, and the pressure contact force of the feeding roller 604c to the driven roller 604d becomes large. Hence, even if the biasing force of the elastic member 643d is small, a sufficient nip pressure can be obtained between the feeding roller 604c and the driven roller 604d in driving.

On the other hand, in a non-driving state of the feeding roller 604c, only the nip pressure by the biasing of the elastic member 643d acts. When detaching the attaching/detaching unit 640 from the main body 100A, it is possible to reduce the resistance derived from the nip between the feeding roller 604c and the driven roller 604d.

The attaching/detaching unit 640 according to this embodiment uses the feeding motor 623 provided in the main body 100A as the driving source of the feeding rollers 604a and 604c. When the driving source is arranged outside, the necessity of an electric wiring work can be obviated when attaching/detaching the attaching/detaching unit 640.

Hence, the attaching/detaching unit 640 includes a transmission mechanism that transmits the driving force of the feeding motor 623. Referring to FIG. 33, the transmission mechanism includes an input portion 6401, a driving shaft 6403, and a gear device 6402 beaten the input portion 6401 and the driving shaft 6403. In this embodiment, the input portion 6401 is a gear that rotates about a shaft in the X direction, and is arranged on one side portion of the attaching/detaching unit 640 in the X direction. In a state in which the attaching/detaching unit 640 is attached to the main body 100A, the input portion 6401 meshes with an output gear 601c provided in the main body 100A. The output gear 601c is rotated by the driving force of the feeding motor 623. In a state in which the attaching/detaching unit 640 is detached from the main body 100A, the input portion 6401 and the output gear 601c are separated, and driving transmission is disconnected.

The driving force input to the input portion 6401 is transmitted to the driving shaft 6403 via the gear device 6402. To the feeding rollers 604a and 604c, the driving force is transmitted from the driving shaft 6403. For example, to the feeding roller 604c, the driving force is transmitted via a rotating body (gear) 6404 (FIG. 34) provided on the driving shaft 6403 and the already described rotating body 6405. For the feeding roller 604a as well, the driving force is transmitted by the same mechanism.

The configuration of the sensor 631 will be described next. The sensor 631 includes a light shielding piece 631a, a lever member 631b, a connecting shaft 631c, and a photo interrupter 631d. The photo interrupter 631d is provided in the main body 100A, and FIG. 33 shows the photo interrupter 631d as well.

The connecting shaft 631c is extended in the X direction and supported by the base portion 641 such that it can rotate about the X-axis as the rotation center. The lever member 631b is attached to one end portion of the connecting shaft 631c and can rotate about a shaft in the X-axis direction together with the connecting shaft 631c.

As shown in FIG. 34, the distal end of the lever member 631b extends in the radial direction of the connecting shaft 631c and projects to the conveyance path RT6a. The distal end of the lever member 631b is located in a region between the path forming member 640a and the path forming member 640b. For this reason, even if the attaching/detaching unit 640 is detached from the main body 100A, the periphery of the distal end of the lever member 631b is surrounded by the path forming member 640a and the path forming member 640b, and it is difficult for the operator to touch it. This can prevent the lever member 631b from breaking.

The light shielding piece 631a is attached to the other end portion of the connecting shaft 631c with respect to the lever member 631b, and can rotate about a shaft in the X-axis direction together with the connecting shaft 631c. The light shielding piece 631a is a plate-shaped member having a fan shape and extending in the radial direction of the connecting shaft 631c. The light shielding piece 631a is arranged on one side portion of the attaching/detaching unit 640 in the X direction. The light shielding piece 631a and the input portion 6401 are located on opposite side portions of the left and right side portions of the attaching/detaching unit 640.

The photo interrupter 631dis an optical sensor having a light emitting portion EL and a light receiving portion RL. A slit between the light emitting portion EL and the light receiving portion RL is opened to the front side of the main body 100A. In a state in which the attaching/detaching unit 640 is attached to the main body 100A, the light shielding piece 631a is located in the slit between the light emitting portion EL and the light receiving portion RL. Since the slit is opened to the front side of the main body 100A, the light shielding piece 631a and the photo interrupter 631d do not contact at the time of attachment/detachment of the attaching/detaching unit 640. When the photo interrupter 631d is arranged in the main body 100A, the necessity of an electric wiring work can be obviated when attaching/detaching the attaching/detaching unit 640.

As shown in FIG. 34, if the sheet SH does not exist in the conveyance path RT6a, the lever member 631b is located at such a position that its distal end projects to the conveyance path RT6a due to biasing of an elastic member 631e. At this time, the light shielding piece 631a blocks the optical axis between the light emitting portion EL and the light receiving portion RL of the photo interrupter 646, as shown in FIG. 36. In this embodiment, the elastic member 631e is a torsion coil spring.

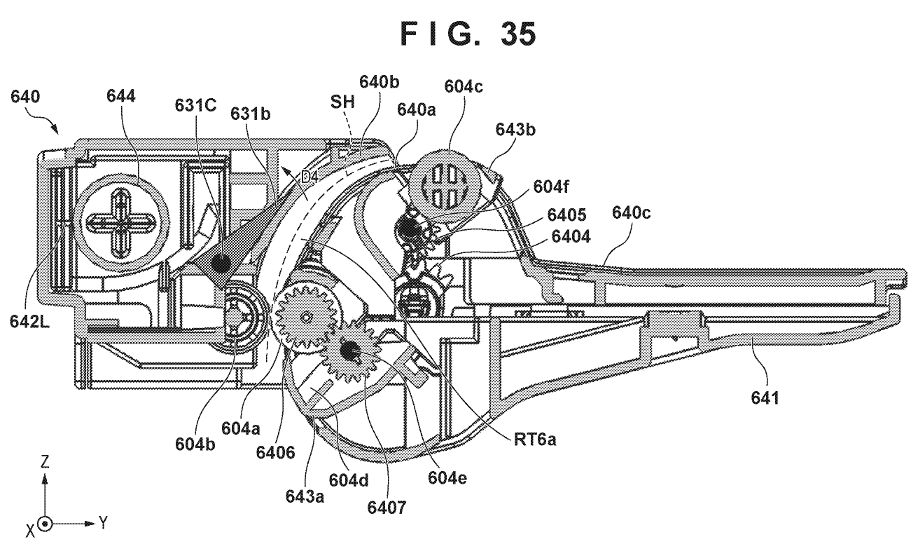

On the other hand, as shown in FIG. 35, when the sheet SH passes through the conveyance path RT6a, the lever member 631b contacts the sheet SH and rotates in the direction of an arrow D4 to a position to avoid the sheet SH. More specifically, the leading edge of the sheet SH abuts against the lever member 631b and pushes this upward, thereby rotating the lever member 631b. The lever member 631b is located at a position where the projection amount to the conveyance path RT6a is small or it is retreated from the conveyance path RT6a.

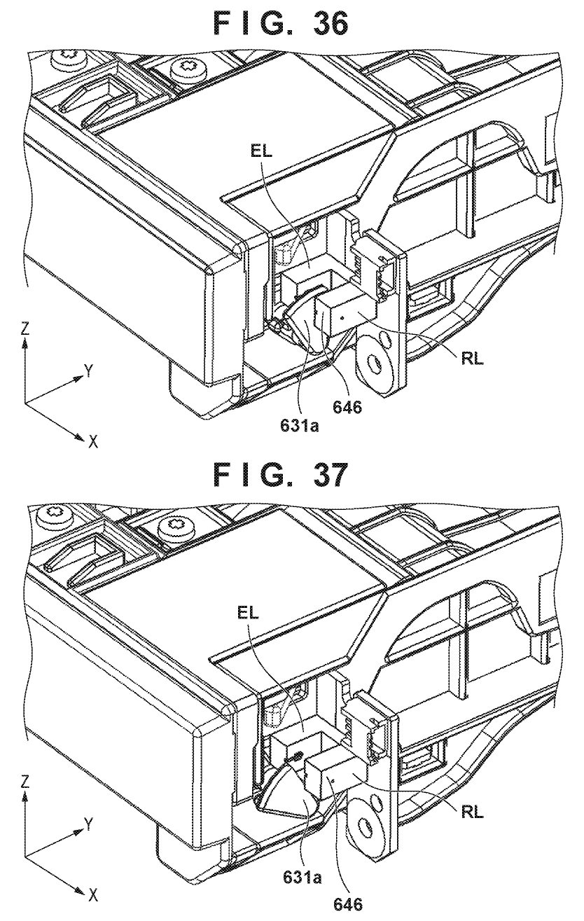

At this time, the light shielding piece 631a is in a state in which it does not block the optical axis between the light emitting portion EL and the light receiving portion RL of the photo interrupter 631d (a state in which the light receiving portion RL is receiving light from the light emitting portion EL), as shown in FIG. 37. It is therefore possible to recognize the position of the sheet SH by monitoring the detection result of the photo interrupter 631d.

When the sheet SH passes through the conveyance path RT6a, the lever member 631b is returned to the position shown in FIG. 34 by the biasing of the elastic member 631e, and the light shielding piece 631a blocks the optical axis between the light emitting portion EL and the light receiving portion RL of the photo interrupter 631d, as shown in FIG. 36. In this embodiment, the biasing force of the elastic member 631e is used to return the lever member 631b to the position in FIG. 34, but the weight of the lever member 631b itself may be used.

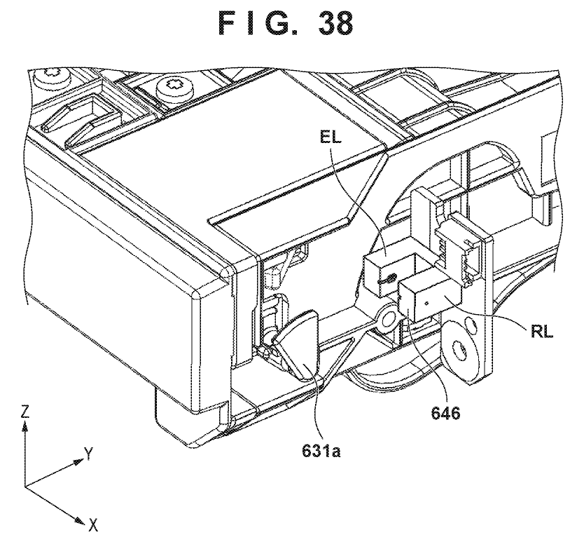

Even in a case where the attaching/detaching unit 640 is detached from the main body 100A, the light shielding piece 631a is in the state in which it does not block the optical axis between the light emitting portion EL and the light receiving portion RL of the photo interrupter 631d (the state in which the light receiving portion RL is receiving light from the light emitting portion EL), as shown in FIG. 38. Upon detecting, at the time of stop of conveyance of the sheet SH, that the light receiving portion RL is receiving light from the light emitting portion EL, it can be determined that the attaching/detaching unit 640 is detached from the main body 100A.

### Seventh Embodiment

In the sixth embodiment, a lever member 631b is a part of a sensor 631 that detects a sheet SH. However, the lever member 631b may be used even for an application purpose other than the sensor. For example, the lever member 631b may be used for an application purpose of a posture guide for moving the position of the sheet SH to one side in a conveyance path RT6a.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A printing apparatus comprising:
a storage cassette on which a print medium is stacked;
a conveying unit configured to convey the print medium to a printhead;
a carriage on which the printhead is mounted; and
a driving unit configured to move the carriage,
wherein the storage cassette is configured to be attached/detached from a front surface of a main body of the printing apparatus in a front/rear direction of the printing apparatus with respect to the main body,
the conveying unit is configured to convey the print medium from a front side to a rear side in the front/rear direction, and
the driving unit is configured to move the carriage in a direction crossing the front/rear direction and is arranged on the rear side with respect to the printhead in the front/rear direction.

2. The printing apparatus according to claim 1, wherein
the conveying unit is arranged on the front side with respect to the printhead in the front/rear direction.

3. The printing apparatus according to claim 1, further comprising a feeding unit configured to convey the print medium from the storage cassette to the conveying unit,
wherein the feeding unit is arranged on the front side with respect to the conveying unit in the front/rear direction.

4. The printing apparatus according to claim 1, further comprising an attaching/detaching unit configured to be attached/detached from the front surface of the main body in the front/rear direction with respect to the main body,
wherein the attaching/detaching unit is configured to form a conveyance path of the print medium conveyed from the storage cassette.

5. The printing apparatus according to claim 4, wherein
the storage cassette is located on a lower side of the attaching/detaching unit.

6. The printing apparatus according to claim 3, further comprising an inverting path configured to invert the print medium that has passed through the printhead and convey the print medium to the feeding unit.

7. The printing apparatus according to claim 6, wherein
the inverting path is a path that guides the print medium from the rear side of the printing apparatus to the front side in the front/rear direction.

8. The printing apparatus according to claim 1, further comprising an opening portion provided in an upper portion of a housing of the printing apparatus and configured to expose an interior of the printing apparatus,
wherein the opening portion is formed such that a portion on the front side of the printhead from the opening portion in the front/rear direction is exposed more than a portion on the rear side.

9. The printing apparatus according to claim 8, wherein
the opening portion has a width wider than a width of the print medium.

10. The printing apparatus according to claim 8, further comprising a platen facing the printhead,
wherein the platen is exposed from the opening portion.

11. The printing apparatus according to claim 8, further comprising an opening/closing member configured to open/close the opening portion,
wherein the opening/closing member forms a discharge tray to which a printed print medium is discharged.

12. The printing apparatus according to claim 11, wherein the opening/closing member is a rotation member having a rotation center axis in a direction crossing the front/rear direction.

13. The printing apparatus according to claim 1, wherein
the driving unit comprises:
a guide member extended in the direction crossing the front/rear direction and configured to guide movement of the carriage;
a driving pulley and a driven pulley, which are apart in the direction crossing the front/rear direction;
an endless belt wound between the driving pulley and the driven pulley, to which the carriage is fixed; and
a motor configured to rotate the driving pulley.

14. The printing apparatus according to claim 1, wherein
the printhead discharges ink to the print medium.
